(19) United States
(12) Patent Application Publication
(10) Pub. No.: US 2008/0230096 A1
(43) Pub. Date: Sep. 25, 2008

(54) SUBSTRATE CLEANING DEVICE AND SUBSTRATE PROCESSING APPARATUS

(75) Inventors: Shigeru KAWAMURA, Yamanashi (JP); Teruyuki Hayashi, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/052,065

(22) Filed: Mar. 20, 2008

(30) Foreign Application Priority Data
Mar. 22, 2007 (JP) 2007-074447
Mar. 4, 2008 (JP) 2008-053062

(51) Int. Cl. B08B 7/00; B08B 5/00

(52) U.S. Cl. 134/90; 134/98.1

(57) ABSTRACT

The device forms a flow of a back-side gas over a back-side surface of the end portion of the wafer undergoing a cleaning process executed by radiating an electromagnetic wave such as an ultraviolet ray onto the end portion of the wafer. During the cleaning process, a flow of front-side gas directed along a direction matching the direction of the back-side gas is also formed over the front-side surface of the end portion of the wafer. The flow velocity of the back-side gas is set higher than the flow velocity of the front-side gas. As a result, a descending gas current is created to flow from the wafer front side toward the wafer back side at a gap between the wafer end portion and a partitioning plate, which makes it possible to reliably prevent an active species formed on the back side of the wafer end portion from reaching over to the wafer front side.

### CROSS-REFERENCE TO RELATED APPLICATIONS

This document claims priority to Japanese Patent Application Number 2007-074447, filed on Mar. 22, 2007 and Japanese Patent Application Number 2008-053062, filed on Mar. 4, 2008, the entire content of which are hereby incorporated by reference.

### FIELD OF THE INVENTION

The present invention relates to a substrate cleaning device that cleans an end portion of a substrate such as semiconductor wafer or a liquid crystal substrate and a substrate processing apparatus.

### BACKGROUND OF THE INVENTION

As a substrate such as semiconductor wafer (hereafter may be referred to simply as a “wafer”) undergoes an etching process or a film formation process, an undesirable deposit may come to settle on an end portion area of the wafer (e.g., onto the back side of an edge that includes a beveled area).

For instance, as a wafer undergoes a plasma etching process executed by raising to plasma a processing gas constituted of a fluorocarbon (CF-class) gas, a competing reaction (polymerization reaction) occurs to result in a byproduct (deposit) of a CF polymer settling onto the back side of the wafer end portions and the processing surface on the front side of the wafer (the surface undergoing the processing).

In addition, as a wafer undergoes a film formation process executed by using a CF-class gas to form a CF film on the wafer through chemical vapor deposition (CVD), the CF film may be deposited continuously from the processing surface on the wafer front side through the wafer end portion and further over to the back side of the end portion.

If such a wafer is held at the back side of the end portion or is transferred with the deposit present over the edge area, the deposit adhering onto the back side of the end portion may flake off and become particles that may then adhere onto the wafer processing surface or the processing surface of another wafer. The presence of such particles adhering onto wafer processing surfaces will lower the yield of the semiconductor device production. Accordingly, wafers need to undergo a cleaning process to remove the deposit from the wafer end portions.

Japanese Laid Open Patent Publication No. H10-242098 discloses a method for removing deposit from an end portion of a wafer by radiating an ultraviolet ray onto part of the wafer edge and discharging through an area below the wafer a gas containing oxygen, which is supplied from above. As the ultraviolet ray is radiated onto the wafer edge, oxygen present in the vicinity becomes excited and active species such as ozone (O₃) and active oxygen (O) are generated. The deposit constituted of an organic substance such as a CF polymer present at the wafer end portion is decomposed and vaporized by the active species and thus, the deposit can be removed from the wafer end portion.

However, if the gas containing oxygen is supplied from above while radiating the ultraviolet ray onto the wafer end portion, the flow of the gas is bound to be disrupted over the front-side surface of the wafer. This gives rise to a concern that the active species such as active oxygen formed around the wafer end portion will flow over to the processing surface further inward relative to the wafer end portion to damage a film having been formed on the wafer processing surface.

### SUMMARY OF THE INVENTION

An object of the present invention, having been completed by addressing the issues discussed above, is to provide a substrate cleaning device and a substrate processing apparatus with which a deposit adhering to a substrate end portion can be removed without damaging the processing surface by preventing an active species used to induce chemical decomposition of the deposit, from flowing over to the side where the processing surface of the substrate is present.

The object described above is achieved in an aspect of the present invention by providing a substrate cleaning device that executes a substrate cleaning process to remove the deposit adhering to an end portion of a substrate, comprising a stage on which the substrate can be placed with the end portion thereof projecting beyond the stage, a partitioning plate disposed further outward relative to the substrate end portion so as to enclose the substrate and used to separate a front-side space with respect to the substrate from the back-side space with respect to the substrate, an electromagnetic wave radiating means for radiating an electromagnetic wave, which may be an ultraviolet ray, an infrared ray, an x-ray or a laser beam, toward the back side of the substrate end portion, a front-side gas flow forming means for forming a flow of front-side gas along the front-side surface of the substrate end portion and a back-side gas flow forming means for forming a flow of back-side gas along a back-side surface of the substrate end portion so as to allow the back-side gas to flow with a higher flow velocity than the front-side gas along a direction matching the direction of the flow of the front-side gas.

According to the present invention described above, a back-side gas flow is formed along the back-side surface of the substrate end portion while radiating an electromagnetic wave such as an ultraviolet ray toward the back side of the substrate end portion, so as to generate an active species (e.g., active oxygen) near the back side of the substrate end portion. This active species induces chemical decomposition of a deposit (e.g., a fluorocarbon polymer) adhering to the substrate end portion to vaporize and remove the deposit.

Since the partitioning plate separates the front-side space with respect to the substrate from the back-side space with respect to the substrate, the back-side gas is not allowed to flow into the front-side space. In other words, the active species generated near the back side of the substrate end portion does not reach the front side of the substrate through the back-side gas flow. In addition, a front-side gas flow running along the same direction as the back-side gas flow is formed at the front-side surface of the substrate end portion and the back-side gas is allowed to flow at a higher flow velocity than the front-side gas. As a result, even if there is a gap between the substrate end portion and the partitioning plate via which the front-side space and the back-side space communicate with each other, the pressure on the back side (lower side) of the gap assumes a negative value relative to the pressure on the front side (upper side) of the gap due to the Bernoulli effect, creating a constant gas current at the gap, which flows from the front side toward the back side. In other words, even if there is a gap between the substrate end portion and the partitioning plate, the active species generated near the back side of the substrate end portion does not flow through the gap to reach the front side of the substrate.

According to the present invention described above, the active species generated on the back side of the substrate end portion, to be used to remove the deposit adhering to the substrate end portion, is effectively prevented from reaching over to the front side of the substrate where the processing surface is present and thus, the processing surface is effectively protected from damage.

The object described above is achieved in another aspect of the present invention by providing a substrate cleaning device that executes a substrate cleaning process to remove deposit adhering to an end portion of a substrate, comprising a processing container formed in a tubular shape, a stage disposed inside a processing container, on which the substrate can be placed with the end portion thereof projecting beyond the stage, a partitioning plate disposed further outward relative to the substrate end portion so as to enclose the substrate and used to divide the space inside the processing container into a front-side space with respect to the substrate and a back-side space with respect to the substrate, an electromagnetic wave radiating means, disposed near the substrate end portion so as to range in a ring-shaped shape along the entire periphery of the substrate end, for radiating an electromagnetic wave which may be an ultraviolet ray, an infrared ray, an x-ray or a laser beam, toward a back side of the substrate end portion, a front-side gas flow forming means for forming a flow of a front-side gas directed from an inner side relative to the substrate end portion toward an outer side along a front-side surface of the substrate end portion over the entire periphery of the substrate end portion and a back-side gas flow forming means for forming over the entire periphery of the substrate end portion, a flow of a back-side gas, which flows from the inner side relative to the substrate end portion toward the outer side along a back-side surface of the substrate end portion, with a higher flow velocity than the front-side gas flow.

According to the present invention described above, a back-side gas flow along the back-side surface can be formed over the entire periphery of the substrate end portion while radiating an electromagnetic wave such as an ultraviolet ray onto the back side along the entire periphery of the substrate end portion at once. Thus, an active species (e.g., active oxygen) is generated near the back side over the entire periphery of the substrate end portion, allowing the deposit present over the entire periphery of the substrate end portion to be removed at once through the action of the active species.

Since the partitioning plate separates the front-side space with respect to the substrate from the back-side space with respect to the substrate, the back-side gas is not allowed to flow into the front-side space. In other words, the active species generated near the back side of the substrate end portion over the entire periphery does not reach the front side of the substrate through the back-side gas flow. In addition, a front-side gas flow running along the same direction as the back-side gas flow is formed at the front-side surface of the substrate end portion and the back-side gas is allowed to flow at a higher flow velocity than the front-side gas. As a result, even if there is a gap between the substrate end portion and the partitioning plate, via which the front-side space and the back-side space communicate with each other over the entire periphery of the substrate end portion, the pressure on the back side (lower side) of the gap assumes a negative value relative to the pressure on the front side (upper side) of the gap due to the Bernoulli effect, creating a constant gas current at the gap, which flows from the front side toward the back side. Thus, the active species does not flow through the gap to reach the front side of the substrate.

According to the present invention described above, the active species generated on the back side of the substrate end portion, to be used to remove the deposit adhering to the substrate end portion, is effectively prevented from reaching over to the front side of the substrate where the processing surface is present and thus, the processing surface is effectively protected from damage.

The front-side gas flow forming means may include a front-side gas supply means for supplying the front-side gas from above the front-side space by spraying the front-side gas toward the front-side surface of the substrate and a front-side gas discharge means for discharging through a side of the front-side space the front-side gas flowing from the inner side relative to the substrate end portion toward the outer side along the front-side surface of the substrate end portion.

Through this front-side gas flow forming means at which the front-side gas is sprayed from the front-side gas supply means toward the front-side surface of the substrate, a front-side gas flow through which the front-side gas flows along the front-side surface of the substrate from the inner side relative to the substrate end portion toward the outer side over the entire periphery of the substrate end portion can be formed efficiently. The front-side gas can then be discharged through a side of the front-side space via the front-side gas discharge means without disrupting the flow.

The front-side gas discharge means may include a plurality of front side discharge ports disposed along a circumferential direction at a side wall of the processing container forming the front-side space, via which the front-side gas is discharged. Via the front-side gas discharge means adopting such a structure, the front-side gas flowing from the inner side relative to the substrate end portion toward the outer side along the front-side surface over the entire periphery of the substrate end portion can be discharged reliably without disrupting its flow.

The front-side gas discharge means may be constituted with a ring-shaped front-side gas intake piping disposed at the partitioning plate on the side toward the front-side space, via which the front-side gas having been taken in is discharged. Via the front-side gas discharge means adopting such a structure, the front-side gas flowing from the inner side relative to the substrate end portion toward the outer side along the front-side surface over the entire periphery of the substrate end portion can be discharged reliably without disrupting its flow.

In the front-side gas discharge means described above, an intake port of the front-side gas intake piping may be constituted with a slit formed along the circumference of the piping toward the substrate or it may be constituted with numerous holes formed along the circumference toward the substrate. Via an intake port formed as described above, the front-side gas can be taken into the front-side gas intake piping even more reliably, to assure efficient discharge thereof.

The back-side gas flow forming means may include a back-side gas supply means for supplying the back-side gas through an area below the back-side space by spraying the back-side gas toward the back-side surface of the substrate and a back-side gas discharge means for discharging through a side of the back-side space the back-side gas flowing from the inner side relative to the substrate end portion toward the outer side along the back-side surface of the substrate end portion.

Through this back-side gas flow forming means at which the back-side gas is sprayed from the back-side gas supply means toward the back-side surface of the substrate, a back-side gas flow through which the back-side gas flows along the back-side surface of the substrate from the inner side relative to the substrate end portion toward the outer side over the entire periphery of the substrate end portion can be formed efficiently. The back-side gas can then be discharged through a side of the back-side space via the back-side gas discharge means without disrupting the flow.

The back-side gas discharge means may include a plurality of back side discharge ports disposed along a circumferential direction at a side wall of the processing container forming the back-side space, via which the back-side gas is discharged. Via the back-side gas discharge means adopting such a structure, the back-side gas flowing from the inner side relative to the substrate end portion toward the outer side along the back-side surface over the entire periphery of the substrate end portion can be discharged reliably without disrupting its flow.

The back-side gas discharge means may be constituted with a ring-shaped back-side gas intake piping disposed at the partitioning plate on the side toward the back-side space, via which the back-side gas having been taken in is discharged. Via the back-side gas discharge means adopting such a structure, the back-side gas flowing from the inner side relative to the substrate end portion toward the outer side along the back-side surface over the entire periphery of the substrate end portion can be discharged reliably without disrupting its flow.

In the back-side gas discharge means described above, an intake port of the back-side gas intake piping may be constituted with a slit formed along the circumference of the piping toward the substrate or it may be constituted with numerous holes formed along the circumference toward the substrate. Via an intake port formed as described above, the back-side gas can be taken into the back-side gas intake piping even more reliably, to assure efficient discharge thereof.

The back-side gas flow forming means may include a back-side gas outlet piping disposed to range in a ring-shaped shape over the entire periphery of the substrate end portion further inward relative to the substrate end portion of the substrate placed on the stage, through which the back-side gas is let out along the back-side surface of the substrate end portion, and a back-side gas intake piping disposed so as to range in a ring-shaped shape over the entire periphery of the substrate end portion to face opposite the back-side gas outlet piping further outward relative to the substrate end portion of the substrate placed on the stage, through which the back-side gas let out through the back-side gas outlet piping is taken in.

Through the back-side gas flow forming means structured as described above, the back-side gas is let out along the back-side surface of the substrate end portion from the back-side gas outlet piping disposed to range in a ring-shaped shape over the entire periphery of the substrate end portion further inward relative to the end portion of the substrate placed on the stage and, as a result, a back-side gas flow through which the back-side gas flows from the inner side relative to the substrate end portion toward the outer side along the back-side surface over the entire periphery of the substrate end portion can be formed efficiently. In addition, the back-side gas flow forming means includes the back-side gas intake piping disposed to range in a ring-shaped shape over the entire periphery of the substrate end portion so as to face opposite the back-side gas outlet piping further outward relative to the end portion of the substrate placed on the stage. The back-side gas let out through the back-side gas outlet piping can then be reliably taken in through the back-side gas intake piping without disrupting its flow.

The back-side gas outlet piping may include a back-side gas outlet port through which the back-side gas is let out, whereas the back-side gas intake piping may include a back-side gas intake port through which the back-side gas is taken in. The back-side gas outlet port and the back-side gas intake port may be constituted with slits facing opposite each other and each formed along the circumference of the corresponding piping. Alternatively, the back-side gas outlet port and the back-side gas intake port may be constituted with numerous holes facing opposite each other and formed along the circumferences of the respective pipings.

Via the back-side gas outlet piping and the back-side gas intake piping structured as described above, a back-side gas flow through which the back-side gas flows from the inner side relative to the substrate end portion toward the outer side along the back-side surface over the entire periphery of the substrate end portion can be created efficiently.

The object described above is achieved in yet another aspect of the present invention by providing a substrate cleaning device that executes a substrate cleaning process to remove the deposit adhering to an end portion of a substrate, comprising a processing container formed in a tubular shape, a stage disposed inside the processing container, on which the substrate can be placed with the end portion thereof projecting beyond the stage, a partitioning plate disposed further outward relative to the substrate end portion so as to enclose the substrate and used to divide the space inside the processing container into a front-side space with respect to the substrate from the back-side space with respect to the substrate, an electromagnetic wave radiating means, disposed near the substrate end portion so as to range in a ring-shaped shape along the entire periphery of the substrate end, for radiating an electromagnetic wave which may be an ultraviolet ray, an infrared ray, an x-ray or a laser beam, toward a back side of the substrate end portion, a front-side gas flow forming means for forming a flow of a front-side gas directed from an outer side relative to the substrate end portion toward an inner side along a front-side surface of the substrate end portion over the entire periphery of the substrate end portion and a back-side gas flow forming means for forming over the entire periphery of the substrate end portion a back-side gas flow with a higher flow velocity than the front-side gas flow, which flows from the outer side relative to the substrate end portion toward the substrate end portion.

According to the present invention described above, a back-side gas flow along the back-side surface can be formed over the entire periphery of the substrate end portion while radiating an electromagnetic wave such as an ultraviolet ray onto the back side along the entire periphery of the substrate end portion at once. Thus, an active species (e.g., active oxygen) is generated near the back side over the entire periphery of the substrate end portion, allowing the deposit present over the entire periphery of the substrate end portion to be removed at once through the action of the active species.

Since the partitioning plate separates the front-side space with respect to the substrate from the back-side space with respect to the substrate, the back-side gas is not allowed to flow into the front-side space. In other words, the active species generated near the back side of the substrate end portion over the entire periphery does not reach the front side of the substrate through the back-side gas flow. In addition, a front-side gas flow running along the same direction as the back-side gas flow is formed at the front-side surface of the substrate end portion and the back-side gas is allowed to flow at a higher flow velocity than the front-side gas. As a result, even if there is a gap between the substrate end portion and the partitioning plate, via which the front-side space and the back-side space communicate with each other over the entire periphery of the substrate end portion, the pressure on the back side (lower side) of the gap assumes a negative value relative to the pressure on the front side (upper side) of the gap due to the Bernoulli effect, creating a constant gas current at the gap, which flows from the front side toward the back side. Thus, the active species does not flow through the gap to reach the front side of the substrate.

According to the present invention described above, the active species generated on the back side of the substrate end portion, to be used to remove the deposit adhering to the substrate end portion, is effectively prevented from reaching over to the front side where the processing surface is present and thus, the processing surface is effectively protected from damage.

The electromagnetic wave radiating means may use a lamp light source or a laser light source to radiate a circular electromagnetic wave. Via the electromagnetic wave radiating means assuming such a structure, too, an electromagnetic wave, which may be an ultraviolet ray, an infrared ray or a laser beam, can be radiated at once onto the back side over the entire periphery of the substrate end portion to generate an active species.

The deposit adhering onto the substrate end portion includes carbon atoms and fluorine atoms. Accordingly, it is desirable that the front-side gas and the back-side gas both contain, at least, oxygen atoms. It is also desirable that the oxygen content in the front-side gas and the back-side gas both be within the range of 1˜15%. The deposit can be reliably removed by using these gases.

The object described above is further achieved in another aspect of the present invention by providing a substrate processing apparatus comprising a processing unit that includes a plurality of processing chambers where substrates are processed in a low pressure environment and a transfer unit that is connected to the processing unit and includes a transfer chamber via which a substrate is transferred at atmospheric pressure to/from a substrate storage container where the substrate are stored. The substrate processing apparatus further comprises a cleaning chamber connected to the transfer chamber, where the deposit adhering to an end portion of a substrate is removed in an environment of atmospheric pressure. The cleaning chamber includes a stage on which the substrate can be placed with the end portion thereof projecting beyond the stage, a partitioning plate disposed further outward relative to the substrate end portion so as to enclose the substrate and used to separate a front-side space with respect to the substrate from a back-side space with respect to the substrate, an electromagnetic wave radiating means for radiating an electromagnetic wave, which may be an ultraviolet ray, an infrared ray, an x-ray or a laser beam, toward the back side of the substrate end portion, a front-side gas flow forming means for forming a flow of the front-side gas along the front-side surface of the substrate end portion and a back-side gas flow forming means for forming a flow of a back-side gas along a back-side surface of the substrate end portion so as to allow the back-side gas to flow with a higher flow velocity than the front-side gas along a direction matching the direction of the flow of the front-side gas.

The object described above is also achieved in yet another aspect of present invention by providing a substrate processing apparatus equipped with a plurality of processing chambers where substrate are processed in a low pressure environment with one of the plurality of processing chambers used as a cleaning chamber where the deposit adhering onto an end portion of a substrate is removed in the low pressure environment. The cleaning chamber includes a stage on which the substrate can be placed with the end portion thereof projecting beyond the stage, a partitioning plate disposed further outward relative to the substrate end portion so as to enclose the substrate and used to separate a front-side space with respect to the substrate from a back-side space with respect to the substrate, an electromagnetic wave radiating means for radiating an electromagnetic wave, which may be an ultraviolet ray, an infrared ray, an x-ray or a laser beam, toward a back side of the substrate end portion, a front-side gas flow forming means for forming a flow of a front-side gas along the front-side surface of the substrate end portion and a back-side gas flow forming means for forming a flow of a back-side gas along the back-side surface of the substrate end portion so as to allow the back-side gas to flow with a higher flow velocity than the front-side gas along a direction matching the direction of the flow of the front-side gas.

According to the present invention described above, the active species used to remove a deposit adhering to the substrate end portion by inducing chemical decomposition of the deposit, is effectively prevented from reaching over to the processing surface on the substrate front side and thus, the processing surface is effectively protected from damage.

### BRIEF DESCRIPTION OF THE DRAWINGS

FIG. 1 is a sectional view, presenting a structural example for the substrate processing apparatus achieved in a first embodiment of the present invention;

FIG. 2 illustrates how a deposit such as a CF polymer may settle onto a wafer end portion;

FIG. 3A is an enlarged sectional view of an end portion of a wafer with a silicon oxide film formed thereupon, that has undergone a plasma etching process executed by using a processing gas constituted with a CF class gas;

FIG. 3B is an enlarged sectional view of an end portion of the wafer W that has undergone a CF film formation process executed through chemical vapor deposition to form a CF film on the wafer surface with a CF class gas;

FIG. 4 is a perspective providing a schematic external view of the processing container at the cleaning processing chamber achieved in the embodiment;

FIG. 5 is a longitudinal sectional view schematically illustrating the internal structure of the cleaning processing chamber in the embodiment;

FIG. 6 is a perspective showing the structure assumed over an area near the stage in the embodiment;

FIG. 7 schematically illustrates the flows of the front-side gas and the back-side gas near a wafer end portion and the partitioning plate inner circumferential end portion;

FIG. 8 is a graph showing the relationship of the oxygen content to the quantities of residual carbon atoms and fluorine atoms, observed by radiating ultraviolet rays onto a CF film over a predetermined length of time and varying the oxygen content in the oxygen-containing gas;

FIG. 9 is a longitudinal sectional view of the internal structure of processing container disposed in the cleaning chamber in a second embodiment of the present invention;

FIG. 10 is a schematic external view of the ultraviolet lamp, the back-side gas outlet piping and the back-side gas intake piping taken as the stage in the processing container in the embodiment is viewed diagonally from below; and

FIG. 11 is a longitudinal sectional view of the internal structure of processing container disposed in the cleaning chamber in a third embodiment of the present invention.

### DETAILED DESCRIPTION OF THE PREFERRED EMBODIMENTS

The following is a detailed explanation of preferred embodiments of the present invention, given in reference to the attached drawings. It is to be noted that in the specification and the drawings, the same reference numerals are assigned to components having substantially identical functions and structural features to preclude the necessity for a repeated explanation thereof.

### Structural Example for the Substrate Processing Apparatus in the First Embodiment

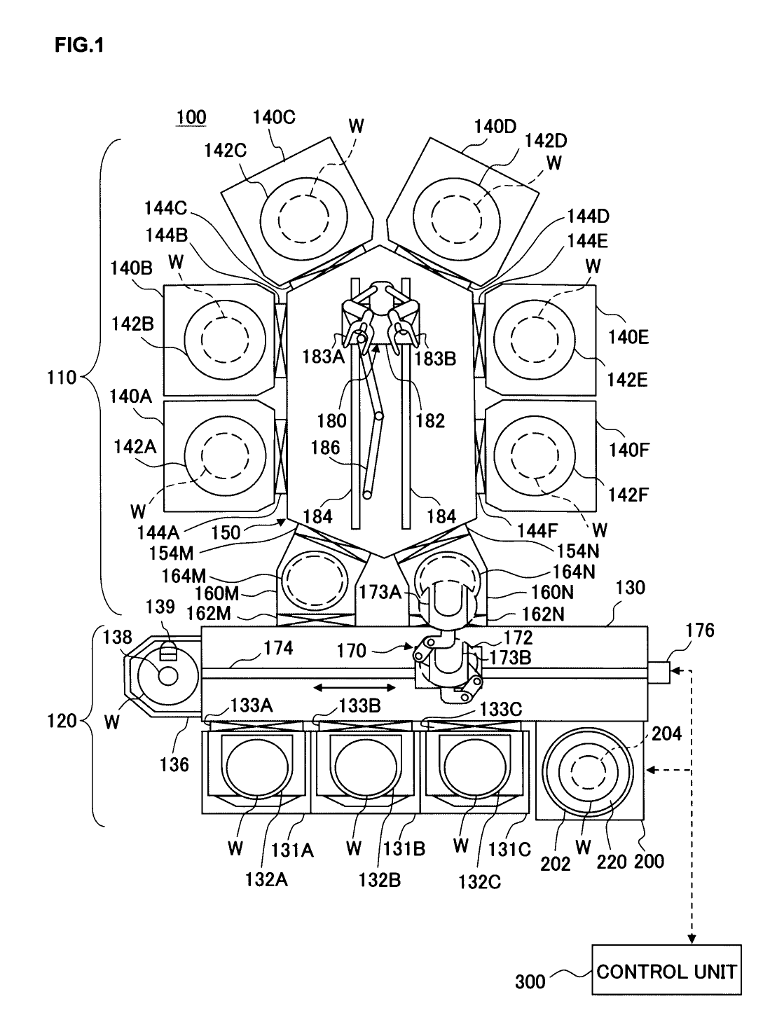

First, the substrate processing apparatus achieved in the first embodiment of the present invention is explained in reference to drawings. FIG. 1 schematically shows the structure adopted in the substrate processing apparatus in the first embodiment of the present invention. The substrate processing apparatus 100 comprises a processing unit 110 that includes a plurality of processing chambers where substrates e.g., semiconductor wafers W, undergo various types of processing such as film formation processing and etching within a low pressure environment and a transfer unit 120 that transfers the wafers W to/from the processing unit 110.

The transfer unit 120 includes a transfer chamber 130 via which wafers W are transferred between substrate storage containers such as cassette containers 132 (132A˜132C) and the processing unit 110 as shown in FIG. 1. The transfer chamber 130 is formed as a box with a substantially polygonal section. On one side of the transfer chamber 130 along the longer side of its substantially polygonal section, a plurality of cassette stages 131 (131A˜131C) are disposed side-by-side. The cassette containers 132A˜132C both representing an example of the substrate storage containers can be placed on the cassette stages 131A˜131C respectively.

The cassette containers 132 (132A˜132C) each have a capacity for housing up to, for instance, 25 wafers W stacked with uniform pitches with the wafers W held at their ends by a holding portion. The cassette containers adopt a sealed structure with their inner spaces filled with, for instance, an N₂ gas atmosphere. The wafers W can be transferred between the transfer chamber 130 and the cassette containers 132 (132A˜132C) via gate valves 133 (133A˜133C) disposed between the cassette containers 132 (132A˜132C) and the transfer chamber 130. It is to be noted that the quantities of cassette stages 131 and cassette containers 132 are not limited to those shown in FIG. 1.

A cleaning chamber 200, representing an example of the substrate cleaning device, is connected to the transfer chamber 130 at one side surface thereof. A wafer W having undergone a specific type of processing such as etching or film formation undergoes a cleaning process in the cleaning chamber 200 so as to remove undesirable deposit adhering to the end portions thereof. It is to be noted that the structure adopted in the cleaning chamber 200 is to be described in detail later.

At an end of the transfer chamber 130, i.e., on one side of its substantially polygonal section along the shorter side, an orienter (pre-alignment stage) 136 to function as a positioning device, which includes a rotary stage 138 and an optical sensor 139 for optically detecting the edge of a wafer W, is installed. This orienter 136 aligns the wafer W by detecting an orientation flat, a notch or the like in the wafer W.

Inside the transfer chamber 130, a transfer unit-side transfer mechanism (transfer chamber internal transfer mechanism) 170 that transfers a wafer W along its longer side (along the direction indicated by the arrow in FIG. 1) is disposed. A base 172 at which the transfer unit-side transfer mechanism 170 is locked is slidably supported on a guide rail 174 extending over the central area inside the transfer chamber 130 along the lengthwise direction. A needle and a stator of a linear motor are respectively disposed at the base 172 and the guide rail 174. A linear motor drive mechanism 176 used to drive the linear motor is disposed at an end of the guide rail 174. A control unit 300 is connected to the linear motor drive mechanism 176. In response to a control signal provided by the control unit 300, the transfer unit-side transfer mechanism 170 is driven along the direction indicated by the arrow together with the base 172 on the guide rail 174.

The transfer unit-side transfer mechanism 170 adopts a double arm structure constituted with two arm units. The arm units each assume an articulated structure allowing the arm unit to bend, move up/down and rotate freely. End effectors 173A and 173B, at which wafers W can be held, are mounted at the front ends of the arms and thus, the transfer unit-side transfer mechanism 170 is able to handle two wafers W at once. Via this transfer unit-side transfer mechanism 170, wafers W can be carried into/out of the cassette containers 132, the orienter 132, first and second load-lock chambers 160M and 160N and the cleaning chamber 200, so as to replace wafers present therein with new wafers. A sensor (not shown) that detects the presence of a wafer W is installed at each of the end effectors 173A and 173B of the transfer unit-side transfer mechanism 170. It is to be noted that the quantity of arm units included in the transfer unit-side transfer mechanism 170 is not limited to that described above and the transfer unit-side transfer mechanism 170 may instead adopt a single arm structure constituted with a single arm unit.

Next, an example of a structure that may be adopted in the processing unit 110 is explained. The processing unit 110 in a cluster tool-type substrate processing apparatus in the embodiment may include a plurality of processing chambers 140 (first through sixth processing chambers 140A˜140F) and the first and second load-lock chambers 160M and 160N, all connected around a common transfer chamber 150 formed so as to have a polygonal section (e.g., a hexagonal section), as shown in FIG. 1, with a high level of air-tightness.

In the processing chambers 140A˜140F, a single specific type of processing or different specific types of processing, e.g., film formation processing (such as plasma CVD processing) and/or etching (such as plasma etching), are executed on wafers W based upon, for instance, process recipes stored in advance in a storage medium or the like in the control unit 300. Stages 142 (142A˜142F), on which wafers W are placed, are disposed inside the processing chambers 140 (140A˜140F). It is to be noted that the quantity of the processing chambers 140 is not limited to that shown in FIG. 1.

The common transfer chamber 150 has a function of transferring wafers W between the individual processing chambers 140A through 140F described above and/or between the processing chambers 140A through 140F and the first and second load-lock chambers 160M and 160N. The common transfer chamber 150 assumes a polygonal shape (e.g., a hexagonal shape). The processing chambers 140 (140A˜140F), which are disposed around the common transfer chamber, are respectively connected with the common transfer chamber via gate valves 144 (144A˜144F) and the front ends of the first and second load-lock chambers 160M and 160N are respectively connected with the common transfer chamber via gate valves (low pressure-side gate valves) 154M and 154N. The base ends of the first and second load-lock chambers 160M and 160N are connected to the other side surface of the transfer chamber 130 respectively via gate valves (atmospheric pressure-side gate valves) 162M and 162N.

The first and second load-lock chambers 160M and 160N have a function of temporarily holding wafers W and passing them onto subsequent processing phases after pressure adjustment. Inside the first and second load-lock chambers 160M and 160N, transfer stages 164M and 164N, on which a wafer can be placed, are disposed.

A processing unit-side transfer mechanism (common transfer chamber internal transfer mechanism) 180 constituted with, for instance, an articulated arm capable of bending, moving up/down and rotating is disposed inside the common transfer chamber 150. The transfer unit-side transfer mechanism 180 includes two end effectors 183A and 183B and is thus able to handle two wafers W at once. In addition, the processing unit-side transfer mechanism 180 is rotatably supported at a base 182. The base 182 is allowed to slide via a slide drive motor (not shown) on guide rails 184 ranging from the base-end side to the front-end side inside the common transfer chamber 150. It is to be noted that a flexible arm 186, through which the wiring for the arm rotating motor or the like is run, is connected to the base 182. As the processing unit-side transfer mechanism 180 structured as described above slides on the guide rails 184, the processing unit-side transfer mechanism is allowed to access the first and second load-lock chambers 160M and 160N and the individual processing chambers 140A˜140F.

For instance, the processing unit-side transfer mechanism 180 should be positioned toward the base end of the common transfer chamber 150 along the guide rails 184 to access the first and second load-lock chambers 160M and 160N and the processing chambers 140A and 140F disposed facing opposite each other. The processing unit-side transfer mechanism 180 should be set toward the front-end side of the common transfer chamber 150 along the guide rails 184 to access the four processing chambers 140B˜140E. Thus, a single processing unit-side transfer mechanism 180 can be utilized to access all the chambers connected to the common transfer chamber 150, i.e., the processing chambers 140A˜140F and the first and second load-lock chambers 160M and 160N.

It is to be noted that the processing unit-side transfer mechanism 180 may adopt a structure other than that described above, e.g., it may include two transfer mechanisms. Namely, a first transfer mechanism constituted with an articulated arm capable of bending, moving up/down and rotating may be disposed toward the base-end side of the common transfer chamber 150 and a second transfer mechanism constituted with an articulated arm capable of bending, moving up/down and rotating may also be disposed toward the front-end side of the common transfer chamber 150. In addition, the quantity of end effectors included in the processing unit-side transfer mechanism 180 is not necessarily two, and the processing unit-side transfer mechanism 180 may include only a single end effector.

The control unit 300 in the substrate processing apparatus 100 controls the overall operations executed in the substrate processing apparatus 100, including control of the individual processing chambers 140, the transfer unit-side transfer mechanism 170, the processing unit-side transfer mechanism 180, the various gate valves 133, 144, 154 and 162, the orienter 136 and the cleaning chamber 200. The control unit 300 includes a CPU (central processing unit) constituting the main unit thereof, a memory in which programs, recipes and the like are stored and a storage medium such as a hard disk.

(Operations of the Substrate Processing Apparatus)

Next, the operations executed in the substrate processing apparatus 100 structured as described above are described. The substrate processing apparatus 100 is engaged in operation by the control unit 300 based upon a specific program. For instance, a wafer W carried out of one of the cassette containers 132A˜132C via the transfer unit-side transfer mechanism 170 is then carried to the orienter 136 and is placed onto the rotary stage 138 at the orienter 136 where it is positioned. The positioned wafer W is carried out of the orienter 136 and is transferred into the first load-lock chamber 160M or the second load-lock chamber 160N. If a processed wafer W having undergone all the necessary processing is present in the first or second load-lock chamber 160M or 160N, the processed wafer W is first carried out and then the unprocessed wafer W is carried into the load-lock chamber at this time.

The wafer W having been carried into the first or second load-lock chamber 160M or 160N is subsequently carried out of the first or second load-lock chamber 160M or 160N by the processing unit-side transfer mechanism 180, carried into the processing chamber 140 where the wafer W is to undergo processing. In the processing chamber 140, the wafer W is placed on the stage 142 constituting a lower electrode. In the processing chamber 140, a specific processing gas delivered through a showerhead (not shown) constituting an upper electrode facing opposite the lower electrode, high-frequency power at specific levels is applied to the individual electrodes to raise the processing gas to plasma and a specific type of processing such as etching or film formation is executed on the wafer W with the plasma.

The processed wafer W having undergone the processing in the processing chamber 140 is carried out of the processing chamber 140 via the processing unit-side transfer mechanism 180. If the wafer W is to undergo subsequent processing in a plurality of processing chambers 140, the wafer W is taken into another processing chamber 140 to undergo the next specific type of processing.

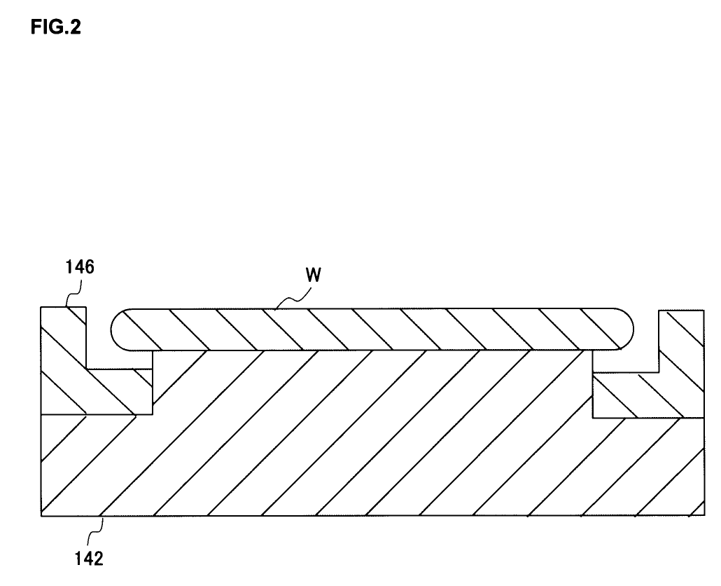

As shown in FIG. 2, the area of the wafer contact surface of the stage 142 upon which the wafer W is placed is normally slightly smaller than the wafer W. Thus, as the wafer W is placed on the stage 142, the end portions of the wafer W project out beyond the stage 142 over the entire periphery thereof.

A focus ring 146 is disposed so as to enclose the wafer W at its edges in a processing chamber 140 where the wafer W undergoes plasma processing, in order to lessen the extent of discontinuity with regard to the bias potential within the plane of the wafer W. The inner diameter of the focus ring 146 is set slightly larger than the outer diameter of the wafer W in order to insure that the focus ring 146 does not come into contact with the wafer W. Thus, there is a slight gap formed between the end surface of the wafer W and the inner circumferential surface of the focus ring 146.

As the wafer W undergoes plasma processing such as etching or film formation, plasma raised from the processing gas enters the gap between the wafer W and the focus ring 146, which may result in undesirable deposit settling onto an end portion of the wafer W. It is to be noted that in a processing chamber without any focus ring 146 disposed therein, too, undesirable deposit may settle onto the end portion of the wafer W processed therein.

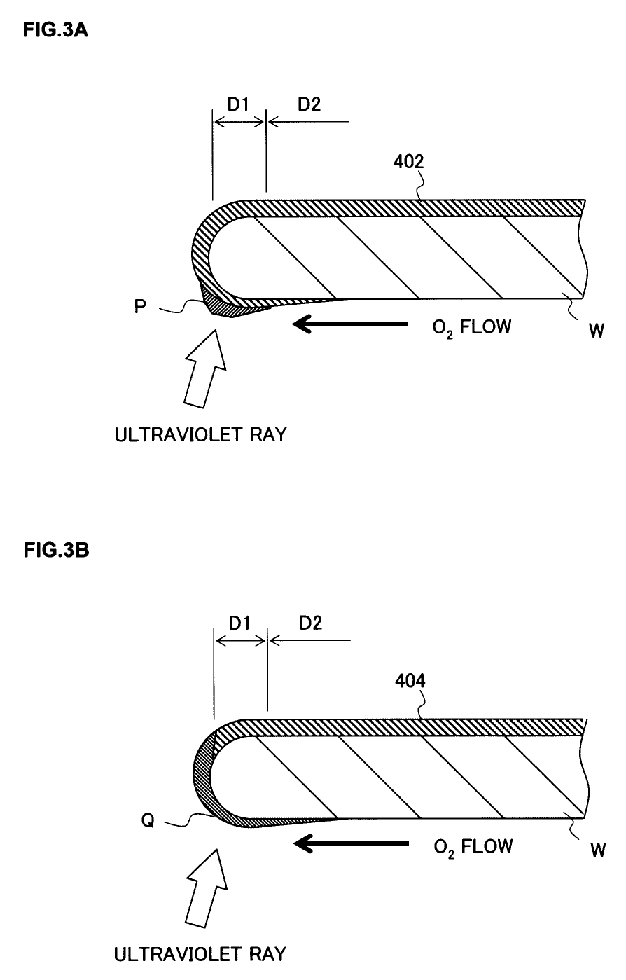

FIG. 3A presents an enlarged sectional view of an end portion of a wafer W having formed thereupon a silicon oxide film (SiO₂ film) 402, which has undergone a plasma etching process executed by using a processing gas constituted with a fluorocarbon (CF class) gas. As shown in FIG. 3A, a byproduct (deposit) constituted of a CF group polymer P, generated through a competing reaction (polymerization reaction) occurring during the plasma etching process, may adhere onto an end portion of the wafer W (e.g., onto the back side of an end portion including a beveled area).

FIG. 3B presents an enlarged sectional view of an end portion of a wafer W having undergone a process of chemical vapor deposition executed to form a CF film 404 at the front surface of the wafer W by using a CF class gas. As shown in FIG. 3B, the CF film 404 formed through the CVD method may range continuously over the front-side surface of the wafer W to the edge of the end portion of the wafer W and further over to the back side (e.g., the beveled area) at the end. The part Q of the CF film 404, which is formed at the end portion of the wafer W, is an undesirable deposit similar to the byproduct settling onto the end portion through the plasma etching process described above, present over an area where no film should be formed.

The deposit (e.g., the CF polymer P or the CF film Q) having settled onto the end portion (e.g., onto the back side of the end portion including the beveled area) during the etching process or the film formation process may subsequently flake off. For instance, as the wafer W is carried back into one of the cassette containers 132A˜132C, the end portion of the wafer W comes into contact with the holding portion inside the cassette container and, at this time, the deposit may flake off readily from the wafer end portion. If the deposit having flaked off from the end portion of the wafer W becomes particles, which may then adhere onto the front surface of the wafer W, the production yield of the semiconductor devices formed on wafers W may be lowered.

Accordingly, the wafer W having undergone the processing in the individual processing chambers 140 is carried into the cleaning chamber 200 via the first or second load-lock chamber 160M or 160N and once the end portion of the wafer W is cleaned in the cleaning chamber 200, the wafer W is taken back into the initial cassette container among the cassette containers 132A˜132C in the substrate processing apparatus 100. Through this cleaning process, the deposit having adhered onto the end portion of the wafer W is removed and thus, the concern that the deposit at the wafer end portion may flake off as the wafer W is carried back into the cassette container 132A, for instance, becomes a non-issue.

(Wafer End Portion Cleaning Process)

Next, the cleaning process executed in the cleaning chamber 200 is described in reference to FIG. 3A. In order to remove deposit constituted of, for instance, the CF polymer P adhering to the back side of the end portion of a wafer W, and electromagnetic wave such as an ultraviolet ray is radiated onto the CF polymer P and also a flow of gas containing, for instance, oxygen (O₂) is formed near the surface of the CF polymer P. As the ultraviolet ray (hν) is radiated onto the CF polymer P, the oxygen present near the CF polymer P becomes excited, generating active oxygen (O) through a chemical reaction such as that expressed in chemical reaction expression (1) below.

O₂+hν→O+O

O₂+O₂→O₃

O₃+hνO₂+O (1)

The active oxygen generated reacts with carbon (C) in the CF polymer P in a decomposition reaction as expressed in chemical reaction expression (2) below, thereby generating carbon dioxide (CO₂) and fluorine (F₂). Through this chemical decomposition, the CF polymer P becomes vaporized and removed.

CₓF_{y}+O→CO₂+F₂ (2)

The CO₂ and the fluorine generated through the reaction expressed in chemical reaction expression (2) are taken into the flow of gas containing oxygen formed near the surface of the CF polymer P and are thus immediately removed. As a result, the surface of the remaining CF polymer P is constantly exposed to the ultraviolet ray and oxygen, further activating the reaction in chemical reaction expression (2) so as to remove the CF polymer P quickly.

While radiating the ultraviolet ray onto the CF polymer P and forming the flow of the gas containing oxygen near the surface of the CF polymer P, the end portion of the wafer W may be heated to a predetermined temperature (e.g., approximately 200° C.). Through this heat application, the reaction expressed in chemical reaction expression (2) is further activated.

It is to be noted that while an explanation is given above on the chemical decomposition reaction induced in order to remove the deposit constituted of the CF polymer P that has adhered onto the wafer end portion during an etching process, as shown in FIG. 3A, the CF film portion Q having adhered to the wafer end portion during a film formation process, as shown in FIG. 3B, too, is basically constituted of C atoms and F atoms and thus can be removed through a chemical decomposition reaction similar to that described above.

In the first embodiment described above, the cleaning process is executed in the cleaning chamber 200 in order to remove deposit (e.g., the CF polymer P or CF film Q) adhering onto the end portion of the wafer W with an active species such as active oxygen generated near the back side of the end portion of the wafer W by radiating an ultraviolet ray onto the back side of the end portion of the wafer W and also forming a flow of a gas containing oxygen.

However, as shown in FIG. 3A and 3B, if a flow of a gas containing oxygen is simply formed so as to run toward the back side of the end portion of the wafer W, the active species such as active oxygen formed through the chemical reaction expressed in chemical reaction expression (1) may travel over to the front side of the end portion of the wafer W. If the active oxygen reaches a device formation area (processing area) D2, which undergoes the processing to form a semiconductor device, located further inward relative to an edge area D1 (e.g., an area ranging 2 mm inward from the edge) at the front-side surface of the wafer W, damage may occur to the film or the like formed on the wafer W.

Accordingly, the space inside the processing container is divided into a wafer front-side space and a wafer back-side space by a partitioning plate disposed so as to surround the periphery of the wafer and thus, the gas flowing on the back side of the wafer during the cleaning process is prevented from flowing into the front-side space in the present invention. Through these measures, the active species generated near the back side of the wafer end portion is prevented from traveling into the wafer front-side space in the flow of the gas at the wafer back side. In addition, during the cleaning process, a flow of front-side gas flowing along the same direction as the back-side gas flow is created on the front side of the wafer end portion. The flow velocity of the back-side gas flow is set higher than that of the front-side gas flow. As a result, it is ensured, due to the Bernoulli effect, that the back-side gas is not allowed to flow over to the front side through the gap between the wafer end portion and the partitioning plate. In other words, even if there is a gap between the wafer end portion and the partitioning plate, the active species generated near the back side of the wafer end portion is not allowed to travel over to the wafer front side through the gap.

(Structural Example for the Cleaning Chamber)

Next, the specific structural example for the cleaning chamber 200 where the cleaning process described above is executed in the first embodiment is explained in reference to drawings. As shown in FIG. 1, the cleaning chamber 200 is equipped with a processing container 202 and a stage 204 on which a wafer W is placed and a partitioning plate 220 positioned so as to enclose the wafer W along its periphery are disposed inside the processing container 202.

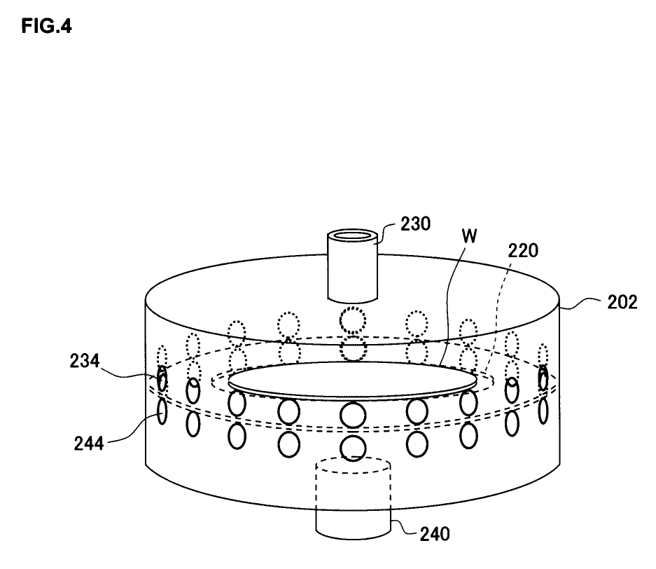

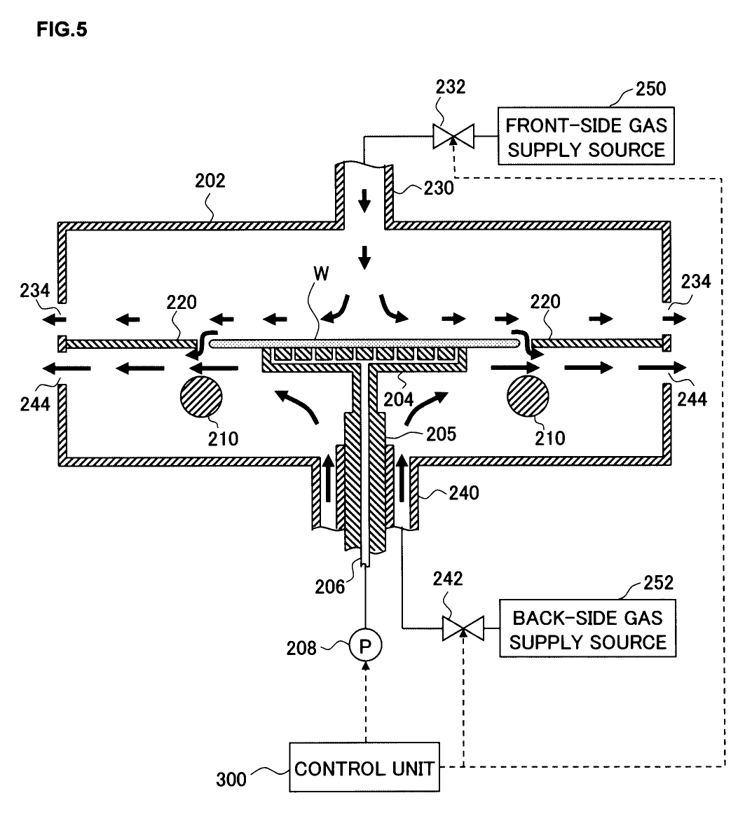

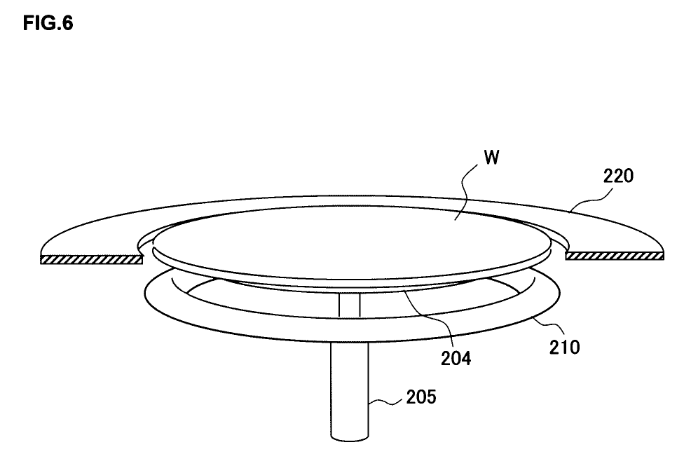

FIG. 4 presents a schematic external view of the processing container 202 in a perspective taken from diagonally above. FIG. 5 is a longitudinal sectional view schematically illustrating the internal structure of the cleaning chamber 200, whereas FIG. 6 shows the structure adopted in the area near the stage 204 in a perspective taken from diagonally above. In FIG. 6, the partitioning plate 220 is shown only partially in order to better illustrate the area near the wafer W. It is to be noted that although not shown in FIG. 4, a gate through which the wafer W is carried into/out of the processing container 202 is disposed over an area of the side wall of the processing container 202.

As shown in FIG. 4, the processing container 202 is formed in a substantially cylindrical shape with the partitioning plate 220 disposed therein to divide the inner space into a front-side space (upper space) relative to the wafer W and a back-side space (lower space) relative to the wafer W. As FIG. 6 also illustrates, the partitioning plate 220 is substantially disk shaped and is attached along its outer circumference to the inner side of the side wall of the processing container 202 along the circumferential direction. A round hole with a diameter slightly larger than the outer diameter of the wafer W is formed at the partitioning plate 220 and the partitioning plate 220 is disposed so that the wafer W is positioned in the round hole. Thus, a gap communicating between the front-side space and the back-side space around the wafer W is created between the wafer W and the partitioning plate 220. In the embodiment, a flow directed from the front-side space toward the back-side space is created in this gap in order to ensure that the back-side gas flow does not reach the front-side space. The specific effect of such a gas flow is to be described in detail later.

It is to be noted that the thickness of the partitioning plate 220 should be set substantially equal to the thickness of the wafer W. As long as the partitioning plate and the wafer W have matching thicknesses, the wafer W and the partitioning plate 220 can be set on a single plane both on the front side and the back side, as shown in FIG. 5, without creating any stage between the end portion of the wafer W and the end portion of the partitioning plate 220. As a result, the gas traveling over the front-side surface and the gas traveling over the back-side surface at the end portion of the wafer W are allowed to flow over the front-side surface and the back-side surface of the partitioning plate 220 to be discharged through the side surface of the processing container 202 with ease.

As shown in FIG. 5, the stage 204 is formed in a disk shape with a diameter smaller than the diameter of the wafer W. Thus, the wafer W can be set on the stage 204 with its entire end portion projecting beyond the stage over the entire periphery thereof. This, in turn, allows the ultraviolet ray to be radiated evenly onto the end portion of the wafer W and facilitates formation of the gas flows at the end portion of the wafer W.

The wafer W is placed on the upper surface of the stage 204. The stage 204 is fixed onto the bottom surface of, for instance, the processing container 202 via a support column 205. It is to be noted that when creating a back-side gas flow at the back-side surface of the wafer end portion by supplying a back-side gas from below the stage 204, as in the embodiment, the thickness of the stage 204 should be set as small as possible and the support column supporting the stage 204 should be as thin as possible. Through these measures, the back-side gas supplied from below the stage 204 is allowed to flow over the back-side surface at the wafer end portion more easily.

Numerous gas intake holes are formed at the upper surface of the stage 204 on which the wafer W is placed, and the gas intake holes are each connected to a pump 208 via a gas intake pipe 206 formed inside the stage 204. As the pump 208 is engaged in operation under control executed by the control unit 300, the wafer W placed on the stage 204 becomes vacuum-held onto the stage upper surface. In other words, the gas intake holes, the gas intake pipe 206 and the pump 208 together function as a vacuum chuck that vacuum-holds the wafer W onto the stage upper surface. Thus, the wafer W is not lifted off the upper surface of the stage 204 by the back-side gas supplied from below the stage 204.

Next, a front-side gas flow forming means for forming a front-side gas flow along the front-side surface of the end portion of the wafer W is described. The front-side gas flow forming means in the embodiment forms a front-side gas flow of a front-side gas sprayed onto the front-side surface of the wafer W from above the front-side space around the wafer W in the processing container 202, which then travels over the front-side surface of the end portion of the wafer W and is discharged through a side of the front-side space.

More specifically, as shown in FIGS. 4 and 5, a front-side gas supply means for supplying the front-side gas by spraying it toward the front-side surface of the wafer W from above the front-side space is disposed at the ceiling of the processing container 202 defining the front-side space. As shown in FIGS. 4 and 5, the front-side gas supply means includes an upper gas supply pipe 230 disposed at the ceiling of the processing container 202, a front-side gas supply source 250 connected to the upper gas supply pipe 230 and the valve 232 via which the flow rate of the front-side gas flowing from the front-side gas supply source 250 to the upper gas supply pipe 230 is controlled. The degree of opening of the valve 232 is controlled in response to a command from the control unit 300 so as to control the flow rate of the front-side gas.

In addition, as shown in FIG. 4, at the side wall of the processing container 202 defining the front-side space, a plurality of front side discharge ports 234 constituting a front-side gas discharge means are arrayed along the circumferential direction. It is desirable that the front side discharge ports 234 be arrayed along the circumference of the partitioning plate 220, as close as possible to the front-side surface of the partitioning plate 220, i.e., over an area of the side wall of the processing container 202 defining the front-side space at a position as low as possible. Through these front side discharge ports, the front-side gas sprayed from the ceiling of the processing container 202 toward the front-side surface of the wafer W is discharged at the side of the processing container 202 after traveling over the front-side surface of the end portion of the wafer W. As a result, a constant front-side gas flow directed from an inner side relative to the end portion of the wafer W toward an outer side is formed at the front-side surface of the end portion of the wafer W.

Next, a back-side gas flow forming means for forming a back-side gas flow along the back-side surface of the end portion of the wafer W is described. The back-side gas flow forming means in the embodiment forms a back-side gas flow of a back-side gas sprayed onto the back-side surface of the wafer W from below the back-side space around the wafer W in the processing container 202, which then travels over the back-side surface of the end portion of the wafer W and is discharged through a side of the back-side space.

As shown in FIGS. 4 and 5, a back-side gas supply means for supplying the back-side gas by spraying it toward the back-side surface of the wafer W from below the back-side space is disposed at the floor of the processing container 202 defining the back-side space. More specifically, the back-side gas supply means includes a lower gas supply pipe 240 disposed at the floor of the processing container 202, a back-side gas supply source 252 connected to the lower gas supply pipe 240 and a valve 242 via which the flow rate of the back-side gas flowing from the back-side gas supply source 252 to the lower gas supply pipe 240 is controlled. The degree of opening of the valve 240 is controlled in response to a command from the control unit 300 so as to control the flow rate of the back-side gas.

The end of the lower gas supply pipe 240 is connected to the floor of the processing container 202 so as to enclose the periphery of the support column 205 supporting the stage 204, as shown in FIG. 5. The end of the lower gas supply pipe 240 may assume a double-layer structure and, in such a case, the support column 205 supporting the stage 204 may be fixed inside the inner pipe and the back-side gas may be supplied through the space between the inner pipe and the outer pipe. Through these measures, the back-side gas can be sprayed toward the back side of the wafer W through the space between the inner pipe and the outer pipe.

In addition, as shown in FIG. 4, at the side wall of the processing container 202 defining the back-side space, a plurality of back side discharge ports 244 constituting a back-side gas discharge means are arrayed along the circumferential direction. It is desirable that the back side discharge ports 244 be arrayed along the circumference of the partitioning plate 220, as close as possible to the back-side surface of the partitioning plate 220, i.e., over an area of the side wall of the processing container 202 defining the back-side space at a position as high as possible. Through these back side discharge ports, the back-side gas sprayed from the floor of the processing container 202 toward the back-side surface of the wafer W is discharged at the side of the processing container 202 after traveling through the back-side surface of the end portion of the wafer W. As a result, a constant back-side gas flow directed from the inner side relative to the end portion of the wafer W toward the outer side is formed at the back-side surface of the end portion of the wafer W.

It is to be noted that the front side discharge ports 234 and the back side discharge ports 244 should each be connected to a vacuum pump or the like so as to induce a suction force. Via such a system, the front-side gas and the back-side gas are reliably sucked out through the front side discharge ports 234 and the back side discharge ports 244 to stabilize the gas flows. In addition, several flow regulating fins may be formed inside the processing container 202 so as to further stabilize the flows of the front-side gas and the back-side gas, supplied toward the wafer W through the upper gas supply pipe 230 and the lower gas supply pipe 240, along the front-side surface and the back-side surface around the wafer W.

The front-side gas and the back-side gas should both contain at least oxygen. While air, which contains oxygen, may be used as the front-side gas and the back-side gas, it is more desirable to use a mixed gas containing oxygen and an inert gas (e.g., nitrogen gas) since such an oxygen-containing gas allows easy oxygen content adjustment. The embodiment is described in reference to an example in which an oxygen-containing gas is supplied from the front-side gas supply source 250 and the back-side gas supply source 252.

It is to be noted that the oxygen content in the front-side gas supplied from the front-side gas supply source 250 and the oxygen content in the back-side gas supplied from the back-side gas supply source 252 may be equal to each other or they may be different from each other. It is also to be noted that if the oxygen contents in the front-side gas and the back-side gas are set equal to each other, the front-side gas supply source 250 and the back-side gas supply source 252 may be constituted with a single gas supply source. Since the oxygen content in the oxygen-containing gas affects the effectiveness with which the deposit at the end portion of the wafer W is removed, an oxygen-containing gas with the optimal oxygen content should be supplied from the front-side gas supply source 250 and the back-side gas supply source 252. It is to be noted that the relationship between the oxygen content in the oxygen-containing gas and the deposit removal effect is to be described in detail later.

The flow velocities of the front-side gas and the back-side gas can be adjusted by controlling the flow rates of the front-side gas and the back-side gas respectively via the valve 232 at the upper gas supply pipe 230 and the valve 242 at the lower gas supply pipe 240 mentioned earlier. Through this adjustment, the flow velocity of the back-side gas flowing over the back side of the wafer end portion can be set higher than the flow velocity of the front-side gas flowing over the front side of the wafer end portion, so as to enable the Bernoulli effect.

The inner diameter of the upper gas supply pipe 230 is greater than that of the lower gas supply pipe 240 in the first embodiment. In this situation, matching flow rates may be selected for the front-side gas flowing into the upper gas supply pipe 230 and the back-side gas flowing into the lower gas supply pipe 240 by controlling the valves 232 and 242, so as to set a higher flow velocity for the back-side gas supplied into the processing container 202 from the lower gas supply pipe 240 than for the front-side gas supplied into the processing container 202 from the upper gas supply pipe 230. It is to be noted that flow rate adjustment units such as mass flow controllers (MFC) may be disposed at the upper gas supply pipe 230 and the lower gas supply pipe 240 and the flow velocities of the front-side gas and that the back-side gas may be adjusted by controlling the flow rates of the front-side gas and the back-side gas via the flow rate adjustment units.

As shown in FIG. 5, an ultraviolet lamp 210 constituting an electromagnetic wave radiating means for radiating an electromagnetic wave, e.g., an ultraviolet ray, toward the back side of the end portion of the wafer W on the stage 204 is disposed inside the processing container 202. The ultraviolet lamp 210, which may assume a ring shape, ranging around the stage 204, as shown in FIG. 6, is disposed at a position set apart by a predetermined distance (e.g., several millimeters) from the back side of the end portion of the wafer W further down relative to the wafer W so as to radiate an ultraviolet ray onto the back side of the end portion of the wafer W. As a flow of the oxygen-containing gas constituting the back-side gas is created over the back-side surface of the end portion of the wafer W and an ultraviolet ray is radiated from the ultraviolet lamp 210 toward the back side of the end portion of the wafer W, an active species such as active oxygen is generated near the end portion of the wafer W, which induces a chemical decomposition reaction at the deposit (e.g., a CF polymer or a CF film) adhering onto the back side of the end portion of the wafer W and thus, the deposit can be removed.

Any of various types of lamps may be used as the ultraviolet lamp 210, including a xenon (Xe) Excimer lamp (with a wavelength of 172 nm) and a low-pressure mercury lamp (with wavelengths of approximately 185 nm and approximately 254 nm).

In an atmospheric-pressure environment, for instance, light with a shorter wavelength can be absorbed into the deposit with a higher rate and thus, ozone can be generated with the light with higher efficiency. For this reason, an ultraviolet lamp 210 constituted of a low-pressure mercury lamp with relatively large wavelengths rather than a xenon Excimer lamp with a relatively small wavelength can be disposed at a position further set apart from the end portion of the wafer W in the atmospheric-pressure environment. In a low pressure environment, on the other hand, and ultraviolet lamp 210 constituted of a xenon Excimer lamp with a small wavelength, too, can be disposed at the position set well away from the end portion of the wafer W.

For these reasons, it is desirable to install an ultraviolet lamp 210 constituted with a lamp that emits ultraviolet light with a relatively large wavelength (e.g., a low-pressure mercury lamp) in a cleaning chamber 200 at atmospheric pressure during the cleaning process. However, it is desirable to install an ultraviolet lamp 210 constituted with a lamp that emits ultraviolet light with a relatively small wavelength (e.g., a xenon Excimer lamp) in a cleaning chamber 200 at low pressure during the cleaning process. By using the ultraviolet lamp 210 constituted with the optimal type of lamp in correspondence to the pressure inside the cleaning chamber 200, as described above, the degree of freedom with regard to the positions at which the individual components are disposed inside the cleaning chamber 200 can be increased.

It is to be noted that the electromagnetic wave radiating means does not need to be a lamp light source that emits ultraviolet rays, such as the ultraviolet lamp 210 described above, and a lamp light source such as an infrared lamp, which emits infrared rays with a greater wavelength may be used as the electromagnetic wave radiating means. Such an infrared lamp may be, for instance, a near infrared lamp such as a halogen lamp or a far infrared lamp. The wavelengths of light emitted from infrared lamps may be in the range of, for instance, 760 nm˜1000nm, and the near infrared ray range is between 760 nm and 2000 nm. It is to be noted that light with a wavelength matching the wavelength of light that can be readily absorbed into the deposit can be extracted from the whole wavelength range via a wavelength extractor such as a band pass filter and the light thus extracted may be radiated.

Alternatively, a laser light source that emits laser light may be used as the electromagnetic wave radiating means. A laser light source normally emits pointed light, i.e., highly condensed light suitable for convergent radiation through which high-density energy can be applied to the deposit. With such a laser light source, the deposit can be heated to a high temperature instantly and the laser light radiation range (processing width) can be controlled with ease. The laser light may be LD (semiconductor) laser, YAG laser, Excimer laser or another type of laser light.

If a laser light source is used as the electromagnetic wave radiating means, the laser light may be radiated onto part of the periphery of the back side of the wafer end portion or the laser light may be radiated over the entire periphery on the back side of the wafer end portion. If the laser light is to be radiated only over part of the wafer end portion, the laser light may be radiated as the wafer rotates via a rotatable stage 204. In such a case, the wafer should be made to rotate at a speed at which the rotation does not disrupt the descending gas flow formed in the gap between the wafer end portion and the partitioning plate 220, which flows from the wafer front side toward the wafer back side. In addition, if the laser light is to be radiated over the entire periphery of the wafer end portion, a single laser light source may be utilized to radiate the entire periphery of the wafer end portion with circular laser light formed via a reflecting mirror, or a plurality of laser light sources, disposed in a circular pattern along the entire periphery of the wafer end portion along the circumferential direction, may be utilized.

(Specific Example of the Cleaning Process)

Next, a specific example of the cleaning process executed in the cleaning chamber 200 in the first embodiment to clean the wafer end portion is explained in reference to FIG. 5. In the cleaning chamber 200, the cleaning process is executed with the various components therein controlled by the control unit 300 of the substrate processing apparatus 100.

First, the wafer W is carried into the cleaning chamber 200 and is placed on the stage 204. An oxygen-containing gas with uniform oxygen content is supplied both as the front-side gas and the back-side gas into the processing container 202 through the front-side gas supply source 250 and the back-side gas supply source 252. The flow rates of the front-side gas and the back-side gas are controlled via the valve 232 at the upper gas supply pipe 230 and the valve 242 at the lower gas supply pipe 240 respectively so as to adjust the flow velocity of the back-side gas to a level higher than the flow velocity of the front-side gas.

As indicated by the arrows in FIG. 5, the front-side gas originating from the front-side gas supply source 250 is sprayed via the upper gas supply pipe 230 toward the area near the center of the front-side surface of the wafer W placed on the stage 204, spreads substantially radially flows from the inner side relative to the end portion of the wafer W toward the outer side over the entire periphery of the end portion of the wafer W among the front-side surface of the wafer W and also flows toward the plurality of front side discharge ports 234 formed at the side wall of the processing container 202.

The back-side gas originating from the back-side gas supply source 250 is sprayed via the lower gas supply pipe 240 toward the back-side of the stage 204 or the back-side surface of the wafer W spreads substantially radially flows from an inner side relative to the end portion of the wafer W toward the outer side over the entire periphery of the end portion of the wafer W along the back-side surface of the wafer W and also flows toward the plurality of back side discharge ports 244 formed at the side wall of the processing container 202.

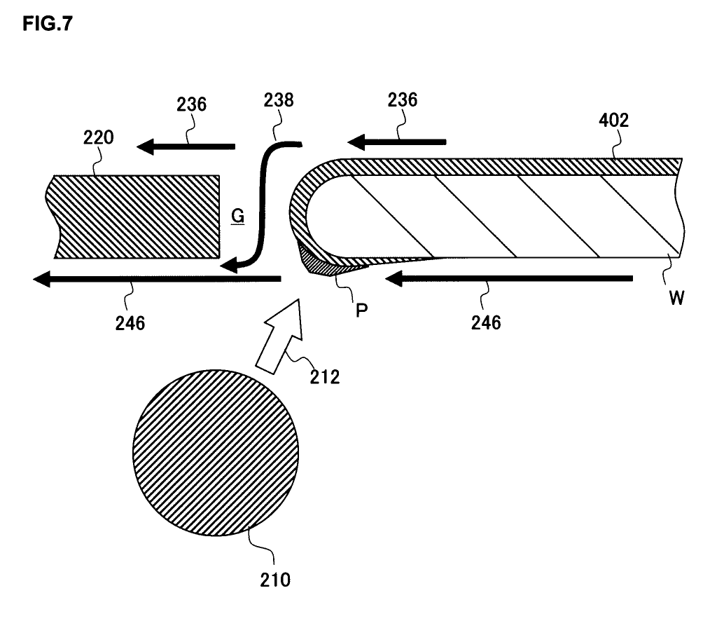

At this time, a back-side gas flow running along the direction matching the direction of the front-side gas flow formed at the front-side surface is formed at the back-side surface near the end portion of the wafer W. More specifically, the front-side gas 236 flows from the inner side relative to the end portion of the wafer W toward the outer side along the front-side surface of the wafer W and further flows along the front-side surface of the partitioning plate 220, as shown in FIG. 7. The back-side gas 246 flows from the inner side relative to the end portion of the wafer W toward the outer side along the back-side surface of the wafer W and further flows along the back-side surface of the partitioning plate 220.

Since the flow velocity of the back-side gas 246 is adjusted to a level higher than the flow velocity of the front-side gas 236, a descending gas current 238 directed from the front-side space around the wafer W toward the back-side space around the wafer W is created in a gap G between the end portion of the wafer W and the inner circumferential end portion of the partitioning plate 220. This phenomenon is due to the Bernoulli effect.

Namely, the difference between the flow velocity of the front-side gas 236 and the flow velocity of the back-side gas 246 creates a localized pressure difference in the gap G with the back-side gas pressure staying lower than the front-side gas pressure at the wafer W, which creates the descending gas current 238, through which part of the front-side gas 236 flows through the gap G toward the back side of the wafer W. As a result, the back-side gas flow is not allowed to reach the front-side space around the wafer W through the gap G. it is to be noted that while a pressure difference is created between the front side and the back side of the wafer W, the wafer W, which is held onto the stage 204 via the vacuum chuck mechanism as described above, is not become lifted off the stage.

Next, in the cleaning chamber with the flow of the front-side gas 236 and the flow of the back-side gas 246 created therein as described above, an ultraviolet ray 212 is radiated from the ultraviolet lamp 210 toward the back side of the end portion of the wafer W. The ultraviolet ray 212 radiated over the entire periphery of the end portion of the wafer W excites oxygen in the back-side gas 246 flowing near the end portion of the wafer W and an active species such as active oxygen is generated through a chemical reaction such as that expressed in chemical reaction expression (1). The active oxygen induces a chemical decomposition reaction such as that expressed in chemical reaction expression (2) and through this chemical decomposition, the deposit (CF polymer P) adhering over the entire periphery of the wafer end portion is removed all at once.

Since the partitioning plate 220 divides the space inside the cleaning chamber into the front-side space and the back-side space relative to the wafer W, the back-side gas 246 is not allowed to flow into the front-side space. Thus, even the active species generated near the back side of the end portion of the wafer W is not allowed to reach the front side of the wafer W in the flow of the back-side gas 246. Since the constant descending gas current 238 is created in the gap G as described earlier, the active species generated on the back side of the end portion of the wafer W does not travel over to the front side of the wafer W. Consequently, the silicon oxide film 402 formed at the surface of the wafer W remains undamaged by the active species.

It is to be noted that the flow of the front-side gas 236 and the flow of the back-side gas 246 are separated from each other via the partitioning plate 220 so as to create the descending gas current 238 at the gap G with a high level of reliability. However, as long as the directions and the flow velocities of the front-side gas 236 and the back-side gas 246 are adjusted with a high level of accuracy, the descending gas current 238 can be created with or without the partitioning plate 220. In other words, as long as the flow directions and velocities are adjusted accurately, the partitioning plate 220 is not required.

(Oxygen Content in the Oxygen-Containing Gas)

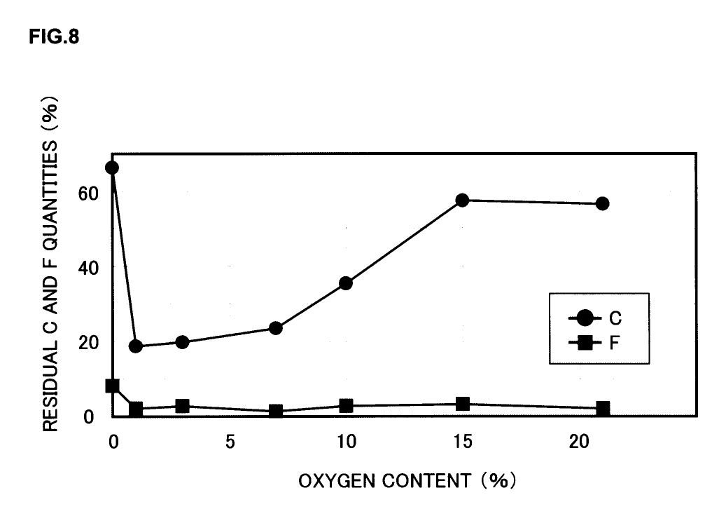

Next, the results of tests conducted to observe the relationship between the oxygen content in the oxygen-containing gas used in the cleaning process and the level of deposit removal effect are described in reference to drawings. The tests were conducted by using sample wafers, which included a CF film formed on a silicon oxide film and mixed gases with varying oxygen content, all constituted with oxygen and nitrogen. The sample wafers underwent a process in which a gas flow was created over the surface of the CF film formed on the wafer W and the quantity of the residual CF film on the sample wafer was measured following the process. FIG. 8 presents a graph of the relationship between the oxygen content and the remaining CF film quantity, observed by executing the process with varying mix ratios of oxygen and nitrogen, with the oxygen content set at 0% (no oxygen), 1%, 3%, 7%, 10%, 15% and 21%.

In the tests, the residual CF film quantities were measured by analyzing the surfaces of the sample wafers having undergone the process. More specifically, and electron beam was radiated to the surface of each sample wafer at approximately 5° and the ratios of C and F in the CF film to all the atoms (Si and 0 in the base and C and F in the CF film) present in the area reaching to a specific depth from the surface were measured based upon the electron spectrum emanated as a result of the electron beam radiation. In other words, lower ratios of C and F to all the atoms in the graph presented in FIG. 8 indicates lower C and F counts, which indicates a greater extent of removal of the CF film.

The test results presented in FIG. 8 indicate that while the residual C and F quantities remained almost unchanged within an oxygen concentration range of 15%˜21%, C and F were reduced to a greater extent when the oxygen content was set equal to or less than 15%. C and F decreased to the largest extent when the oxygen content was approximately 1˜3%. Namely, the test results indicate that the CF polymer can be removed more efficiently with gas flows created with an oxygen-containing gas having an oxygen content set to approximately 1˜3%, much lower than 21%.

The test results indicate that it is desirable to use an oxygen-containing gas with an oxygen concentration of 1˜3% as the back-side gas 246 and use an oxygen-containing gas with an oxygen concentration of 1˜3% as the front-side gas 236 in the first embodiment. It is to be noted that part of the front-side gas 236 forming the descending gas current 238 enters the back-side space and joins the flow of the back-side gas 246 through the gap G present between the end portion of the wafer W and the partitioning plate in the embodiment. For this reason, it is desirable to form the flow of the front-side gas 236 with an oxygen-containing gas having matching oxygen content to the oxygen content in the oxygen-containing gas used to create the flow of the back-side gas 246. By using an oxygen-containing gas with a uniform oxygen concentration of 1˜3% both as the front-side gas 236 and the back-side gas 246 as described above, the oxygen concentration over the space near the deposit can be sustained at 1˜3%, i.e., the most effective oxygen content level for deposit removal.

As described above, the flow of the back-side gas 246 is created on the back side of the end portion of the wafer W by using the oxygen-containing gas with its oxygen concentration adjusted to 1˜3%, optimal for decomposition of the deposit into carbon and fluorine. In addition, since the descending gas current 238 is created by adjusting the flow velocities of the front-side gas 236 and the back-side gas 246, the active species generated on the back side of the wafer W is not allowed to travel over to the front side. As a result, an undesirable deposit such as a CF polymer or a CF film adhering to the back side of the end portion of the wafer W can be selectively and efficiently removed without damaging a film such as the silicon oxide film 402 formed at the surface of the wafer W.

### Second Embodiment

Next, the cleaning chamber achieved in the second embodiment of the present intention is described in reference to drawings. The front-side gas discharge means in the front-side gas flow forming means and the back-side gas discharge means in the back-side gas flow forming means in the second embodiment are respectively constituted with a front-side gas intake piping 270 and a back-side gas intake piping 284 mounted on the front side and the back side of the partitioning plate, via which the front-side gas and the back-side gas are taken in and discharged, instead of the front side discharge ports 234 and the back side discharge ports 244 formed at the side wall of the processing container in the first embodiment. In addition, the back-side gas supply means in the back-side gas flow forming means in the second embodiment is constituted with a back-side gas outlet piping 280 disposed so as to face opposite the back-side gas intake piping 284, instead of the lower gas supply pipe 240 disposed at the floor of the processing container 202 in the first embodiment.

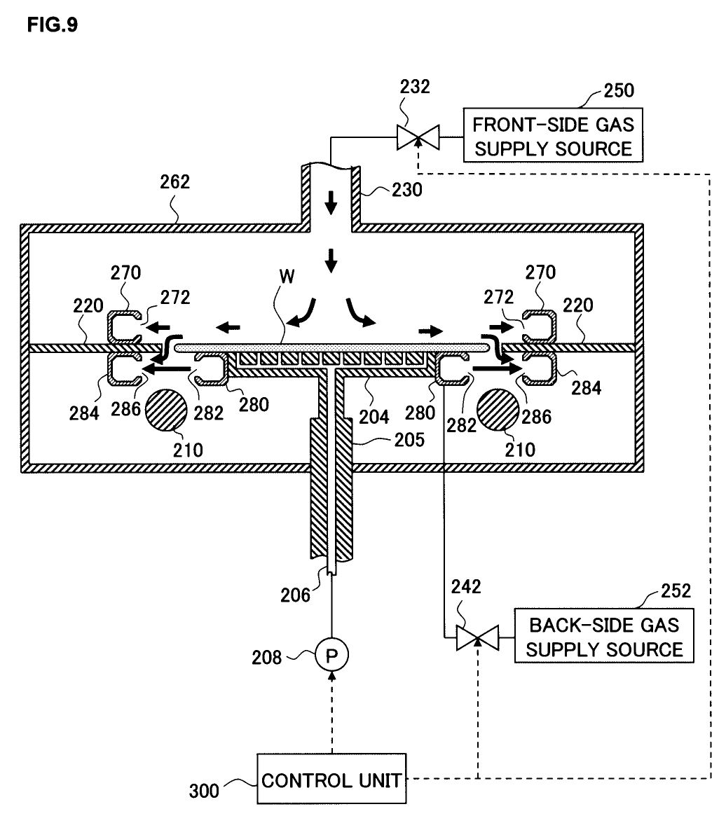

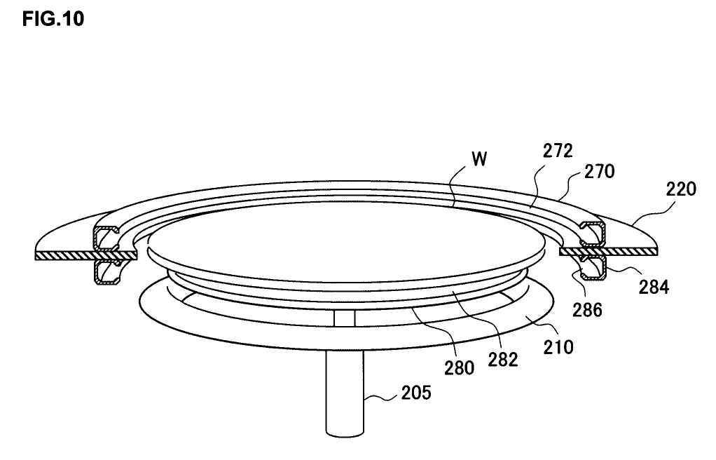

FIG. 9 shows the structure of the cleaning chamber adopted in the second embodiment. FIG. 9 is a longitudinal sectional view schematically showing the internal structure of a processing container 262 in the cleaning chamber achieved in the second embodiment. FIG. 10 is a perspective of an area around the stage 204, taken from diagonally above. In FIG. 10, part of the partitioning plate 220 and parts of the front-side gas intake piping 270 and the back-side gas intake piping 284 are cut off so as to better show the area around the wafer W.

At the processing container 262 in FIG. 9, a stage 204 on which the wafer W is placed, an ultraviolet lamp 210 constituting the ultraviolet ray radiating means for radiating an ultraviolet ray toward the back side of the end portion of the wafer W placed on the stage 204 and a partitioning plate 220 positioned so as to enclose the wafer W on the stage 204 around its edge are disposed. In addition, one end of an upper gas supply pipe 230 constituting the front-side gas supply means is connected to the ceiling of the processing container 262. Since these structural features are similar to those in the processing container 202 in the first embodiment and the second embodiment differs from the first embodiment in that it includes the front-side gas intake piping 270, the back-side gas outlet piping 280 and the back-side gas intake piping 284, a detailed explanation of the identical structural features is omitted and the following explanation focuses on the differences.

As shown in FIGS. 9 and 10, the back-side gas flow forming means in the second embodiment includes the back-side gas outlet piping 280 and the back-side gas intake piping 284 each constituted with a ring-shaped pipe, and a flow of the back-side gas directed from an inner side relative to the wafer end portion toward an outer side is formed along the back-side surface (e.g., the back side of the beveled area) of the wafer end portion as the back-side gas let out through the back-side gas outlet piping 280 is taken into the back-side gas intake piping 284.

In the structural example presented in FIG. 9, the back-side gas outlet piping 280 is disposed so as to range in a circle around the entire periphery of the end portion of the wafer W at a position further inward relative to the end portion of the wafer W placed on the stage 204. In addition, the back-side gas intake piping 284 is disposed so as to range in a circle around the entire periphery of the end portion of the wafer W to face opposite the back-side gas outlet piping 280, at a position further outward relative to the end portion of the wafer W placed on the stage 204. FIG. 9 presents a structural example that includes the back-side gas outlet piping 280 installed at the side surface of the stage 204 and the back-side gas intake piping 284 installed at the back-side surface of the partitioning plate 220.

The back-side gas outlet piping 280 is connected to the back-side gas supply source 252 via a valve 242. At the back-side gas outlet piping 280, a back-side gas outlet port 282 is formed. Through the back-side gas outlet piping 280, the back-side gas originating from the back-side gas supply source 252 is let out at a predetermined flow rate and with a predetermined velocity from the back-side gas outlet port 282 along the back-side surface of the end portion of the wafer W. The back-side gas outlet port 282 is formed so as to range over the entire periphery of the back-side gas outlet piping 280. The back-side gas outlet port 282 may be constituted with a single slit formed along the circumference of the back-side gas outlet piping 280 or it may be constituted with numerous holes formed side-by-side along the circumference of the back-side gas outlet piping 280.

At the back-side gas intake piping 284, the back-side gas intake port 286 through which the oxygen-containing gas is taken in is formed at a position substantially facing opposite the back-side gas outlet port 282 of the back-side gas outlet piping 280. Through the back-side gas intake piping 284, the oxygen-containing gas let out from the back-side gas outlet piping 280 is taken in via the back-side gas intake port 286 and is then discharged. The back-side gas intake port 286, too, is formed so as to range over the entire circumference of the back-side gas intake piping 284. The back-side gas intake port 286 may be constituted with a single slit formed along the circumference of the back-side gas intake piping 284 or it may be constituted with numerous holes formed side-by-side along the circumference of the back-side gas intake piping 284. In addition, the back-side gas intake piping 284 is connected to, for instance, a discharge pump (not shown).

By disposing the back-side gas intake piping 284 and the back-side gas outlet piping 280 as close as possible to each other as described above, the flow of the back-side gas traveling over the back side of the wafer end portion can be stabilized and ultimately, the efficiency with which the deposit present at the end portion of the wafer W is removed can be improved. In addition, since the back-side gas intake piping 284 and the back-side gas outlet piping 280 are each constituted with a ring-shaped pipe, the flow of the back-side gas (oxygen-containing gas) 246 directed from the inner side relative to the end portion of the wafer W toward the outer side along the back-side surface of the end portion of the wafer W is formed over the entire periphery of the end portion of the wafer W, as shown in FIGS. 7 and 9.

The front-side gas flow forming means achieved in the second embodiment includes the front-side gas discharge means constituted with the front-side gas intake piping 270, which is a ring-shaped pipe, and the front-side gas sprayed from the ceiling of the processing container 202 toward the front-side surface of the wafer W flowing along the front-side surface of the end portion of the wafer W is taken in to the front-side gas intake piping 270.

The front-side gas intake piping 270 assumes a shape similar to that of the back-side gas intake piping 284 shown in FIGS. 9 and 10, and is disposed so as to range in a circle around the entire periphery of the end portion of the wafer W at a position further outward relative to the end portion of the wafer W placed on the stage 204. In the example presented in FIG. 9, the front-side gas intake piping 270 is installed at the front-side surface of the partitioning plate 220.

At the front-side gas intake piping 270, a front-side gas intake port 272 opening toward the center of the wafer W, through which the oxygen-containing gas is taken in, is formed. Via the front-side gas intake piping 270, the oxygen-containing gas supplied from the upper gas supply pipe 230 toward the surface of the wafer W is taken in through the front-side gas intake port 272 and is then discharged. The front-side gas intake port 272 is formed over the entire circumference of the front-side gas intake piping 270. The front-side gas intake port 272 may be constituted with a single slit formed along the circumference of the front-side gas intake piping 270 or it may be constituted with numerous holes formed side-by-side along the circumference of the front-side gas intake piping 270. In addition, the front-side gas intake piping 270 is connected to, for instance, a discharge pump (not shown).

By disposing the front-side gas intake piping 270 as close as possible to the end portion of the wafer W as described above, the flow of the front-side gas traveling over the front side of the gas end portion can be stabilized. In addition, since the front-side gas intake piping 270 is constituted with a ring-shaped pipe, the flow of the front-side gas (oxygen-containing gas) 236 directed from the inner side relative to the end portion of the wafer W toward the outer side along the front-side surface of the end portion of the wafer W is formed over the entire periphery of the end portion of the wafer W, as shown in FIGS. 7 and 9.

As described above, a flow of the front-side gas 136 constituted with, for instance, an oxygen-containing gas is formed via the upper gas supply pipe 230 and the front-side gas intake piping 270 and the flow of the back-side gas 246 constituted with an oxygen-containing gas having the same oxygen content as the oxygen-containing gas constituting the front-side gas 236 is formed through the back-side gas outlet piping 280 and the back-side gas intake piping 284. As the ultraviolet ray 212 is radiated from the ultraviolet lamp 210 toward the back side of the end portion of the wafer W in this state, oxygen present near the CF polymer P becomes excited, thereby generating an active species such as active oxygen. This active species reacts with the CF polymer P in a chemical decomposition reaction and, as a result, the CF polymer P is removed.

In the second embodiment, too, the flow velocity of the back-side gas 246 is adjusted to a higher level than the flow velocity of the front-side gas 236, as in the first embodiment. As a result, a descending gas current 238 is created in the gap G located between the end portion of the wafer W and the inner circumferential edge of the partitioning plate 220. The descending gas current blocks the active species generated on the back side of the end portion of the wafer W and this prevents it from reaching the front side of the wafer W. As a result, the silicon oxide film 402 formed at the surface of the wafer W remains undamaged by the active species.

In addition, the back-side gas outlet piping 280 and the back-side gas intake piping 284 can be disposed at positions close to each other in the second embodiment. This structure allows a stable flow of the back-side gas 246 to be formed near the back side of the end portion of the wafer W with a high level of reliability. As a result, the efficiency with which the deposit adhering onto the back side of the end portion of the wafer W is removed is improved.

Furthermore, the front-side gas 236 is readily sucked into the front-side gas intake piping 270, for efficient disposal thereof, and the back-side gas 246 is readily sucked into the back-side gas intake piping 284 for efficient disposal thereof in the second embodiment. Thus, by disposing both the front-side gas intake piping 270 and the back-side gas intake piping 284 at positions close to the gap G between the wafer end portion and the partitioning plate 220, the front-side gas 236 present above the gap G and the back-side gas 246 present under the gap G are allowed to travel in stable flows running parallel to each other. This, in turn, makes it possible to create a descending gas current 238 at the gap G with a high level of reliability so as to effectively prevent the active species from traveling over to the front side of the wafer W.

### Third Embodiment

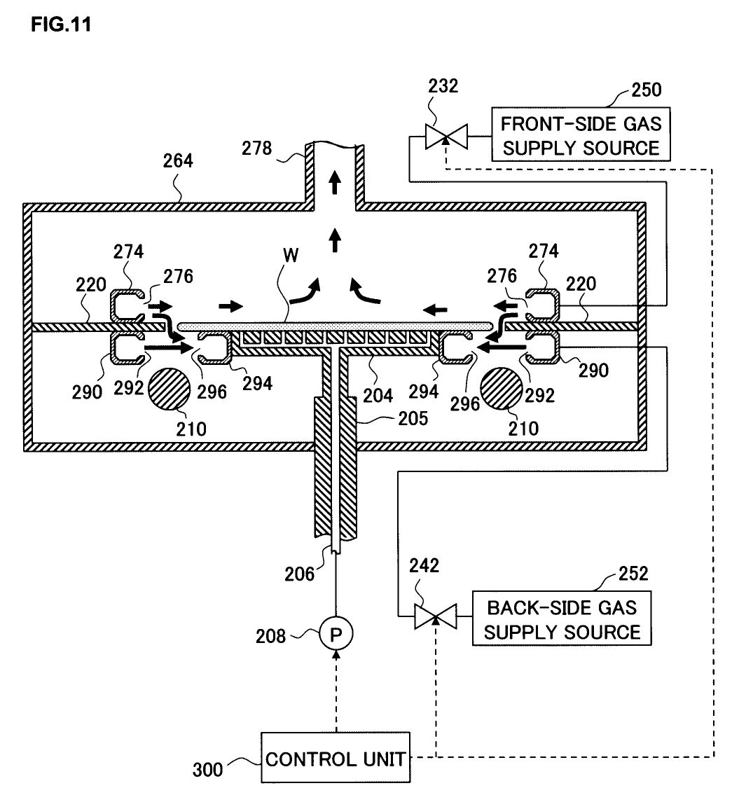

The cleaning chamber achieved in the third embodiment of the present invention is explained next in reference to a drawing. While gas flows directed from the inner side relative to the end portion of the wafer W toward the outer side are created on the front side and the back side of the wafer end portion in the first and second embodiments, an example in which gas flows directed from an outer side relative to the end portion of the wafer W toward an inner side are created on the front side and the back side of the wafer end portion, is described in reference to the third embodiment. FIG. 11 shows the structure of the cleaning chamber achieved in the third embodiment. FIG. 11 is a longitudinal sectional view schematically illustrating the internal structure of a processing container 264 in the cleaning chamber achieved in the third embodiment.

At the processing container 264 in FIG. 11, a stage 204 on which the wafer W is placed, an ultraviolet lamp 210 constituting the ultraviolet ray radiating means for radiating an ultraviolet ray toward the back side of the end portion of the wafer W placed on the stage 204 and a partitioning plate 220 positioned so as to enclose the wafer W on the stage 204 around its edge are disposed. These structural features are identical to those in the processing container 262 in the second embodiment and the third embodiments differs from the second embodiment only in that the gas discharge/supply relationship with regard to the front-side gas and the back-side gas is reversed from that in the second embodiment. Accordingly, a detailed explanation of identical features is omitted and the following explanation focuses on the differences.

The front-side gas flow forming means in the third embodiment includes a front-side gas supply means for supplying the front-side gas from a side of the front-side space with respect to the wafer W in the processing container 264 and a front-side gas discharge means for discharging the front-side gas flowing from an outer side relative to the end portion of the wafer W toward an inner side over the front-side surface of the end portion of the wafer W by sucking the front-side gas from above the front-side space.

More specifically, the front-side gas supply means in the third embodiment is constituted with a front-side gas outlet piping 274 disposed so as to range in a circle around the entire periphery of the end portion of the wafer W placed on the stage 204, positioned further outward relative to the end portion of the wafer W, via which the front-side gas is let out.

The front-side gas outlet piping 274 is connected to the front-side gas supply source 250 via a valve 232. At the front-side gas outlet piping 274, a front-side gas outlet port 276 is formed. Through the front-side gas outlet piping 274, an oxygen-containing gas originating from the front-side gas supply source 250 is let out at a predetermined flow rate and with a predetermined velocity from the front-side gas outlet port 276 toward the front-side surface of the end portion of the wafer W. The front-side gas outlet port 276 is formed so as to range over the entire periphery of the front-side gas outlet piping 274. The front-side gas outlet port 276 may be constituted with a single slit formed along the circumference of the front-side gas outlet piping 274 or it may be constituted with numerous holes formed side-by-side along the circumference of the front-side gas outlet piping 274.

In addition, the front-side gas discharge means in the third embodiment is constituted with an upper discharge pipe 278 disposed at the ceiling of the processing container 264, via which the front-side gas is discharged. A discharge pump (not shown), for instance, may be connected to the upper discharge pipe 278 and in such a case, as the discharge pump is driven, the front-side gas inside the processing container 264 can be sucked upward and discharged.

Via the front-side gas flow forming means in the third embodiment described above, a flow of the front-side gas directed along the direction opposite from the direction in which the front-side gas 236 flows over the front-side surface of the end portion of the wafer W as shown in FIG.7, i.e., directed from the outer side relative to the end portion of the wafer W toward the inner side, is created over the entire periphery of the wafer end portion.

The back-side gas flow forming means in the third embodiment includes a back-side gas outlet piping 290 and a back-side gas intake piping 294 each constituted with a ring-shaped pipe, and a flow of the back-side gas directed from the outer side relative to the wafer end portion toward the inner side is formed along the back-side surface (e.g., the back side of the beveled area) of the wafer end portion as the back-side gas let out through the back-side gas outlet piping 290 is taken into the back-side gas intake piping 294.

In the structural example presented in FIG. 11, the back-side gas outlet piping 290 is disposed so as to range in a circle around the entire periphery of the end portion of the wafer W at a position further outward relative to the end portion of the wafer W placed on the stage 204. In addition, the back-side gas intake piping 294 is disposed so as to range in a circle around the entire periphery of the end portion of the wafer W to face opposite the back-side gas outlet piping 290, at a position further inward relative to the end portion of the wafer W placed on the partitioning plate 220. FIG. 11 presents a structural example that includes the back-side gas outlet piping 290 installed at the back-side surface of the partitioning plate 220 and the back-side gas intake piping 294 installed at the back-side surface of the stage 204.

The back-side gas outlet piping 290 is connected to the back-side gas supply source 252 via a valve 242. At the back-side gas outlet piping 290, a back-side gas outlet port 292 is formed. Through the back-side gas outlet piping 290, the back-side gas originating from the back-side gas supply source 252 is let out at a predetermined flow rate and with a predetermined velocity from the back-side gas outlet port 292 along the back-side surface of the end portion of the wafer W. The back-side gas outlet port 292 is formed so as to range over the entire periphery of the back-side gas outlet piping 290. The back-side gas outlet port 292 may be constituted with a single slit formed along the circumference of the back-side gas outlet piping 290 or it may be constituted with numerous holes formed side-by-side along the circumference of the back-side gas outlet piping 290.

At the back-side gas intake piping 294, the back-side gas intake port 296 through which the oxygen-containing gas is taken in, is formed at a position substantially facing opposite the back-side gas outlet port 292 of the back-side gas outlet piping 290. Through the back-side gas intake piping 294, the oxygen-containing gas let out from the back-side gas outlet piping 290 toward the back-side surface of the end portion of the wafer W is taken in via the back-side gas intake port 296 and is then discharged. The back-side gas intake port 296, too, is formed so as to range over the entire circumference of the back-side gas intake piping 294. The back-side gas intake port 296 may be constituted with a single slit formed along the circumference of the back-side gas intake piping 294 or it may be constituted with numerous holes formed side-by-side along the circumference of the back-side gas intake piping 294. In addition, the back-side gas intake piping 294 is connected to, for instance, a discharge pump (not shown).

Via the back-side gas flow forming means in the third embodiment described above, a flow of the back-side gas directed along the direction opposite from the direction in which the back-side gas 246 flows over the back-side surface, as shown in FIG. 7, i.e., directed from the outer side relative to the end portion of the wafer W toward the inner side, is created over the entire periphery of the wafer end portion.

As described above, a flow of the front-side gas constituted with, for instance, an oxygen-containing gas is formed via the front-side gas outlet piping 274 and the upper discharge pipe 278 and a flow of the back-side gas constituted with an oxygen-containing gas having the same oxygen content as the oxygen-containing gas constituting the front-side gas is formed through the back-side gas outlet piping 290 and the back-side gas intake piping 294 in the third embodiment. As the ultraviolet ray is radiated from the ultraviolet lamp 210 toward the back side of the end portion of the wafer W in this state, oxygen present near the CF polymer P becomes excited, thereby generating an active species such as active oxygen. This active species reacts with the CF polymer P in a chemical decomposition reaction and, as a result, the CF polymer P is removed.

In the third embodiment, too, the flow velocity of the back-side gas is adjusted to a higher level than the flow velocity of the front-side gas, as in the second embodiment. As a result, a descending gas current is created in the gap G located between the end portion of the wafer W and the inner circumferential edge of the partitioning plate 220. The descending gas current blocks the active species generated on the back side of the end portion of the wafer W and thus prevents it from reaching the front side of the wafer W. Consequently, the silicon oxide film formed at the surface of the wafer W remains undamaged by the active species.

While the front-side gas and the back-side gas in the third embodiment flow along the direction opposite from the direction of the flows of the front-side gas 236 and the back-side gas 246 in the second embodiment, advantages similar to those of the second embodiment are also achieved through the third embodiment.

It is to be noted that while the first through third embodiments of the present convention have been explained on an example in which the end portion of the wafer W is cleaned in the atmospheric-pressure environment inside the cleaning chamber 200 disposed in the transfer unit 120, the cleaning process may instead be executed to clean the end portion of the wafer W in a low pressure environment in the cleaning chamber 200 disposed in the processing unit 110. In such case, one of the first through sixth processing chambers 140A˜140F should be designated as the cleaning chamber 200. Advantages similar to those of the first through third embodiments may also be achieved by cleaning the wafer end portion in a low pressure environment.

In addition, while the flow velocities of the front-side gas and the back-side gas are primarily adjusted by the front-side gas supply means and the back-side gas supply means in the first through third embodiment described above, the flow velocities may instead be adjusted by the front-side gas discharge means and the back-side gas discharge means. Alternatively, the flow velocities may be adjusted via both the gas supply means and the gas discharge means.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

What is claimed is:

1. A substrate cleaning device that executes a substrate cleaning process to remove deposit adhering to an end portion of a substrate, comprising:
a stage on which the substrate can be placed with the end portion thereof projecting beyond said stage;
a partitioning plate disposed further outward relative to said substrate end portion so as to enclose the substrate and used to separate a front-side space with respect to the substrate from a back-side space with respect to the substrate;
an electromagnetic wave radiating means for radiating an electromagnetic wave, which may be an ultraviolet ray, an infrared ray, an x-ray or a laser beam, toward a back side of said substrate end portion;
a front-side gas flow forming means for forming a flow of a front-side gas along a front-side surface of said substrate end portion; and
a back-side gas flow forming means for forming a flow of a back-side gas along a back-side surface of said substrate end portion so as to allow said back-side gas to flow with a higher flow velocity than said front-side gas along a direction matching the direction of the flow of said front-side gas.

2. A substrate cleaning device that executes a substrate cleaning process to remove a deposit adhering to an end portion of a substrate, comprising:
a processing container formed in a tubular shape;
a stage disposed inside said processing container, on which the substrate can be placed with the end portion thereof projecting beyond said stage;
a partitioning plate disposed further outward relative to said substrate end portion so as to enclose the substrate and used to divide the space inside said processing container into a front-side space with respect to the substrate and a back-side space with respect to the substrate;
an electromagnetic wave radiating means, disposed near said substrate end portion so as to range in a ring shape along the entire periphery of said substrate end portion, for radiating an electromagnetic wave, which may be an ultraviolet ray, an infrared ray, an x-ray or a laser beam, toward a back side of said substrate end portion;
a front-side gas flow forming means for forming a flow of a front-side gas directed from an inner side relative to said substrate end portion toward an outer side along a front-side surface of said substrate end portion over the entire periphery of said substrate end portion; and
a back-side gas flow forming means for forming, over the entire periphery of said substrate end portion, a flow of back-side gas with a higher flow velocity than said front-side gas flow, which flows from the inner side relative to said substrate end portion toward the outer side along a back-side surface of said substrate end portion.

3. A substrate cleaning device according to claim 2, wherein:
said front-side gas flow forming means includes:
a front-side gas supply means for supplying said front-side gas from above said front-side space by spraying said front-side gas toward said front-side surface of the substrate; and
a front-side gas discharge means for discharging through a side of said front-side space said front-side gas flowing from the inner side relative to said substrate end portion toward the outer side along said front-side surface of said substrate end portion.

4. A substrate cleaning device according to claim 3, wherein:
said front-side gas discharge means includes:
a plurality of front side discharge ports disposed along a circumferential direction at a side wall of said processing container forming said front-side space, via which said front-side gas is discharged.

5. A substrate cleaning device according to claim 3, wherein:
said front-side gas discharge means is constituted with a ring-shaped front-side gas intake piping disposed at said partitioning plate on the side toward said front-side space, via which said front-side gas having been taken in is discharged.

6. A substrate cleaning device according to claim 2, wherein:
said back-side gas flow forming means includes:
a back-side gas supply means for supplying said back-side gas from below said back-side space by spraying said back-side gas toward said back-side surface of the substrate; and
a back-side gas discharge means for discharging through a side of said back-side space said back-side gas flowing from the inner side relative to said substrate end portion toward the outer side along said back-side surface of said substrate end portion.

7. A substrate cleaning device according to claim 6, wherein:
said back-side gas discharge means includes:
a plurality of back side discharge ports disposed along a circumferential direction at a side wall of said processing container forming said back-side space, via which said back-side gas is discharged.

8. A substrate cleaning device according to claim 7, wherein:
said back-side gas discharge means is constituted with a ring-shaped back-side gas intake piping disposed at said partitioning plate on the side toward said back-side space, via which said back-side gas having been taken in is discharged.

9. A substrate cleaning device according to claim 2, wherein:
said back-side gas flow forming means includes:
a back-side gas outlet piping disposed to range in a circle around the entire periphery of said substrate end portion, further inward relative to said substrate end portion of the substrate placed on said stage, through which said back-side gas is let out along said back-side surface of said substrate end portion; and
a back-side gas intake piping disposed so as to range in a circle around the entire periphery of said substrate end portion to face opposite said back-side gas outlet piping, further outward relative to said substrate end portion of the substrate placed on said stage, through which said back-side gas let out through said back-side gas outlet piping is taken in.

10. A substrate cleaning device according to claim 9, wherein:
said back-side gas outlet piping includes a back-side gas outlet port through which said back-side gas is let out; and
said back-side gas intake piping includes a back-side gas intake port through which said back-side gas is taken in.

11. A substrate cleaning device that executes a substrate cleaning process to remove deposit adhering to an end portion of a substrate, comprising:
a processing container formed in a tubular shape;
a stage disposed inside said processing container, on which the substrate can be placed with the end portion thereof projecting beyond said stage;
a partitioning plate disposed further outward relative to said substrate end portion so as to enclose the substrate and used to divide the space inside said processing container into a front-side space with respect to the substrate and a back-side space with respect to the substrate;
an electromagnetic wave radiating means, disposed near said substrate end portion so as to range in a ring shape along the entire periphery of the substrate end portion, for radiating an electromagnetic wave which may be an ultraviolet ray, an infrared ray, an x-ray or a laser beam, toward the back side of said substrate end portion;
a front-side gas flow forming means for forming a flow of a front-side gas directed from an outer side relative to said substrate end portion toward an inner side along a front-side surface of said substrate end portion over the entire periphery of said substrate end portion; and
a back-side gas flow forming means for forming over the entire periphery of said substrate end portion a flow of back-side gas with a higher flow velocity than said front-side gas flow, which flows from the outer side relative to said substrate end portion toward an inner side along a back-side surface of said substrate end portion.

12. A substrate cleaning device according to claim 2, wherein:
said electromagnetic wave radiating means uses a lamp light source or a laser light source to radiate a circular electromagnetic wave.

13. A substrate cleaning device according to claim 2, wherein:
the deposit adhering onto said substrate end portion includes carbon atoms and fluorine atoms.

14. A substrate cleaning device according to claim 2, wherein:
said front-side gas and said back-side gas both contain, at least, oxygen atoms.

15. A substrate cleaning device according to claim 14, wherein:
the oxygen concentration in said front-side gas and said back-side gas are both within a range of 1˜15%.

16. A substrate processing apparatus comprising:
a processing unit that includes a plurality of processing chambers where substrates are processed in a low pressure environment; and
a transfer unit that is connected to said processing unit and includes a transfer chamber via which a substrate is transferred at atmospheric pressure to/from a substrate storage container where the substrate is stored, further equipped with;
a cleaning chamber connected to said transfer chamber where a deposit adhering to an end portion of the substrate is removed in an environment of atmospheric pressure, wherein:
said cleaning chamber includes:
a stage on which the substrate can be placed with the end portion thereof projecting beyond said stage;
a partitioning plate disposed further outward relative to said substrate end portion so as to enclose the substrate and used to separate a front-side space with respect to the substrate from a back-side space with respect to the substrate;
an electromagnetic wave radiating means for radiating an electromagnetic wave which may be an ultraviolet ray, an infrared ray, an x-ray or a laser beam, toward a back side of said substrate end portion;
a front-side gas flow forming means for forming a flow of a front-side gas along a front-side surface of said substrate end portion; and
a back-side gas flow forming means for forming a flow of a back-side gas along a back-side surface of said substrate end portion so as to allow said back-side gas to flow with a higher flow velocity than said front-side gas along a direction matching the direction of the flow of said front-side gas.

17. A substrate processing apparatus equipped with a plurality of processing chambers where substrate are processed in a low pressure environment with one of said plurality of processing chambers used as a cleaning chamber where the deposit adhering onto an end portion of a substrate is removed in the low pressure environment, wherein:
said cleaning chamber includes:
a stage on which the substrate can be placed with the end portion thereof projecting beyond said stage;
a partitioning plate disposed further outward relative to said substrate end portion so as to enclose the substrate and used to separate a front-side space with respect to the substrate from a back-side space with respect to the substrate;
an electromagnetic wave radiating means for radiating an electromagnetic wave, which may be an ultraviolet ray, an infrared ray, an x-ray or a laser beam, toward a back side of said substrate end portion;
a front-side gas flow forming means for forming a flow of a front-side gas along a front-side surface of said substrate end portion; and
a back-side gas flow forming means for forming a flow of a back-side gas along a back-side surface of said substrate end portion so as to allow said back-side gas to flow with a higher flow velocity than said front-side gas along a direction matching the direction of the flow of said front-side gas.
